(19) United States
(12) Patent Application Publication
(10) Pub. No.: US 2023/0275269 A1
(43) Pub. Date: Aug. 31, 2023

(54) ELECTROLYTE AND ELECTROCHEMICAL APPARATUS

(71) Applicant: Ningde Amperex Technology Limited, Ningde, Fujian (CN)

(72) Inventors: Chunrui Xu, Ningde, Fujian (CN); Yanyan Xu, Ningde, Fujian (CN); Jianming Zheng, Ningde, Fujian (CN); Chao Tang, Ningde, Fujian (CN)

(21) Appl. No.: 17/281,548

(22) PCT Filed: Feb. 3, 2021
(86) PCT No.: PCT/CN2021/075012

§ 371 Date: Apr. 17, 2023

(30) Foreign Application Priority Data
Apr. 29, 2020 (CN) 202010357790.4

(51) Int. Cl. H01M 10/0567

(52) U.S. Cl. CPC H01M 10/0567

(57) ABSTRACT

An electrolyte, including an additive A, wherein the additive A comprises a non-fluorinated lithium borate compound; and at least one additive selected from an additive B, an additive C, an additive D, or an additive E, wherein the additive B comprises at least one of vinylene carbonate, fluoroethylene carbonate, lithium tetrafluoroborate, lithium difluoro(oxalato)borate, or lithium difluorophosphate; the additive C comprises a compound comprising S═O; the additive D comprises a compound having 2 to 4 cyano groups; and the additive E comprises a silicon-containing carbonate compound. This application provides an electrolyte and an electrochemical apparatus. The electrolyte includes additives such as a non-fluorinated lithium borate compound, thereby effectively improving high-temperature storage performance, cycle performance, floating charge performance and/or overcharge performance of the electrochemical apparatus.

### CROSS REFERENCE TO RELATED APPLICATIONS

The present application claims the benefit of priority from a National Stage application of PCT international application: PCT/CN2021/075012, filed on 3 Feb. 2021, the disclosure of which is hereby incorporated by reference in its entirety.

### TECHNICAL FIELD

This application relates to the field of energy storage technologies, and in particular, to an electrolyte and an electrochemical apparatus including the electrolyte.

### BACKGROUND

Currently, electrochemical apparatuses (for example, lithium-ion batteries) are widely used in fields such as electric vehicles, consumer electronic products, and energy storage apparatuses. With advantages of high energy density and no memory effect, lithium-ion batteries have gradually become a mainstream battery in these fields. With explosive development of new energy vehicles, the price of lithium cobalt oxides is rising rapidly due to increasingly strained cobalt resources. To reduce costs while increasing energy density and voltage, lithium nickel cobalt manganese has been used more widely. Increasing energy density poses a severe challenge to high-temperature storage and cycle performance of batteries. How to further improve the high-temperature storage and cycle performance of lithium-ion batteries has become a problem to be urgently resolved in the industry.

Using electrolyte additives to improve high-temperature storage and cycle performance is one of means to resolve the foregoing problem. However, most additives improve high-temperature storage performance by forming a film on a positive electrode, but because viscosity of the additive is too high or impedance of the formed film is too large, low-temperature discharge performance and cycle performance of the battery tend to deteriorate severely. Some additives resulting in formed films with low impedance tend to easily deteriorate high-temperature storage performance. To meet the market demand, it is also necessary to develop electrolyte additives that can effectively improve both high-temperature storage performance and cycle performance.

### SUMMARY

The present application provides an electrolyte and an electrochemical apparatus. The electrolyte can improve high-temperature storage and cycle performance of the electrochemical apparatus.

One aspect of the present application provides an electrolyte. In some embodiments, the electrolyte includes:
an additive A, where the additive A includes a non-fluorinated lithium borate compound; and
at least one additive selected from an additive B, an additive C, an additive D, or an additive E, where
the additive B includes at least one of vinylene carbonate, fluoroethylene carbonate, lithium tetrafluoroborate, lithium difluoro(oxalato)borate, or lithium difluorophosphate;
the additive C includes a compound including S═O;
the additive D includes a compound having 2 to 4 cyano groups; and
the additive E includes a silicon-containing carbonate compound.

In some embodiments, the non-fluorinated lithium borate compound includes at least one of a compound I-1, a compound I-2, a compound I-3, a compound I-4, or a compound I-5:

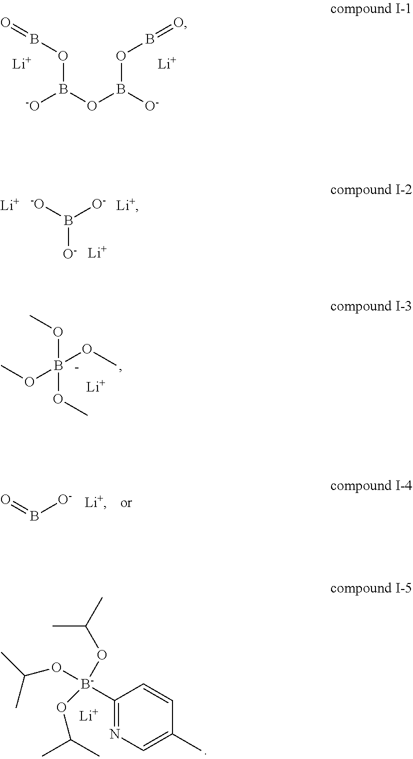

In some embodiments, based on a total weight of the electrolyte, a weight ratio of the additive A to the additive B is 1:1 to 1:200.

In some embodiments, additive A is 0.01% to 2% by weight with respect to the total weight of the electrolyte; and the additive B is 0.1% to 10% by weight with respect to the total weight of the electrolyte.

In some embodiments, the additive B includes lithium difluorophosphate, where based on a total weight of the electrolyte, a weight ratio of the additive A to the lithium difluorophosphate is 10:1 to 1:1, and the lithium difluorophosphate is 0.01% to 1% by weight with respect to the total weight of the electrolyte.

In some embodiments, the additive C includes at least one of a compound represented by a formula II-A, a compound represented by a formula II-B, a compound represented by a formula II-C, or a compound represented by a formula II-D:

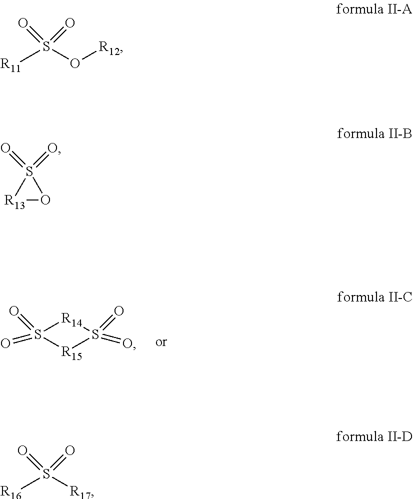

where
R₁₁ and R₁₂ each are independently selected from a substituted or unsubstituted C₁₋₁₀ alkyl group, a substituted or unsubstituted C₂₋₁₀ alkenyl group, a substituted or unsubstituted C₆₋₁₀ aryl group, or a substituted or unsubstituted C₁₋₆ heterocyclic group, where when substitution is performed, a substituent group is one or more of a halogen, a nitro group, a cyano group, or a carboxyl group, and a heteroatom of the heterocyclic group is selected from at least one of O, N, P, and S;
R₁₃ is selected from a substituted or unsubstituted C₁₋₄ alkylidene group, a substituted or unsubstituted C₂₋₄ alkenylene group, or a substituted and unsubstituted C₁₋₆ linear alkane including 1 to 5 heteroatoms, where when substitution is performed, a substituent group is selected from an oxy group, a halogen, a C₁₋₃ alkyl group, or a C₂₋₄ alkenyl group, and the heteroatom is selected from O, N, P or S;
R₁₄ and R₁₅ each are independently selected from O, a substituted or unsubstituted C₁₋₄ alkylidene group, a substituted or unsubstituted C₂₋₄ alkenylene group, or a substituted and unsubstituted C₁₋₆ linear alkane including 1 to 5 heteroatoms, where being substituted means that substitution is performed with one or more substituent groups selected from a halogen, a C₁₋₃ alkyl group, or a C₂₋₄ alkenyl group, and the heteroatom is selected from O, N, P or S; and
R₁₆ and R₁₇ each are independently selected from a substituted or unsubstituted C₁₋₄ alkyl group or a substituted or unsubstituted C₂₋₄ alkenyl group; or R₁₆ and R₁₇ are connected together to form a saturated/unsaturated and substituted/unsubstituted ring including 3 to 6 carbons, where being substituted means that substitution is performed with one or more substituent groups selected from a halogen, a C₁₋₃ alkyl group, or a C₂₋₄ alkenyl group; and
the additive C is 0.1% to 10% by weight with respect to the total weight of the electrolyte.

In some embodiments, the additive D includes at least one of a compound represented by a formula III-A, a compound represented by a formula III-B, a compound represented by a formula III-C, or a compound represented by a formula III-D:

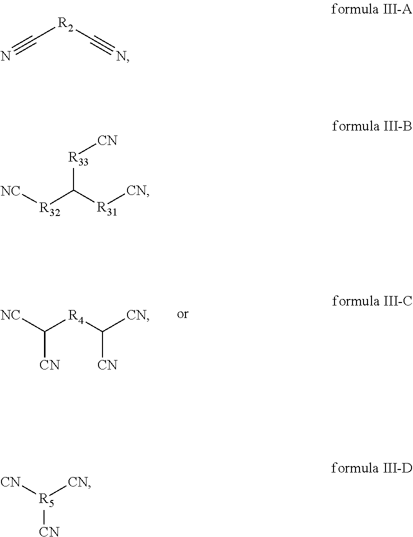

where
R₂ is selected from a C₂₋₁₀ alkenylene group, a C₆₋₁₂ cycloalkylidene group, a C₆₋₁₂ arylene group, —R₀—C₆₋₁₂ arylene-R—, —R₀—S—R—, or —R₀—(O—R)ₙ—,
R₃₁, R₃₂, and R₃₃ each are independently selected from a single bond, a C₁₋₆ alkylidene group, —R₀—(O—R)ₙ—, or —O—R—,
R₄ is selected from a C₁₋₁₀ alkylidene group, a C₂₋₁₀ alkenylene group, a C₆₋₁₂ cycloalkylidene group, a C₆₋₁₂ arylene group, —R₀—S—R—, or —R₀—(O—R)ₙ—,
R₅ is selected from a C₆₋₁₂ trivalent cycloalkyl group or a C₆₋₁₂ trivalent aryl group, where the C₆₋₁₂ trivalent cycloalkyl group or C₆₋₁₂ trivalent aryl group is arbitrarily substituted with 1 to 3 substituent groups selected from a halogen,
R₀ and R each are independently a C₁₋₄ alkylidene group, and
R₂, R₄, R₀, and R each are unsubstituted or substituted with one or more substituent groups selected from a halogen, where
n is a natural number from 0 to 3; and
the additive D is 0.1% to 12% by weight with respect to the total weight of the electrolyte.

In some embodiments, the additive C includes:
at least one of

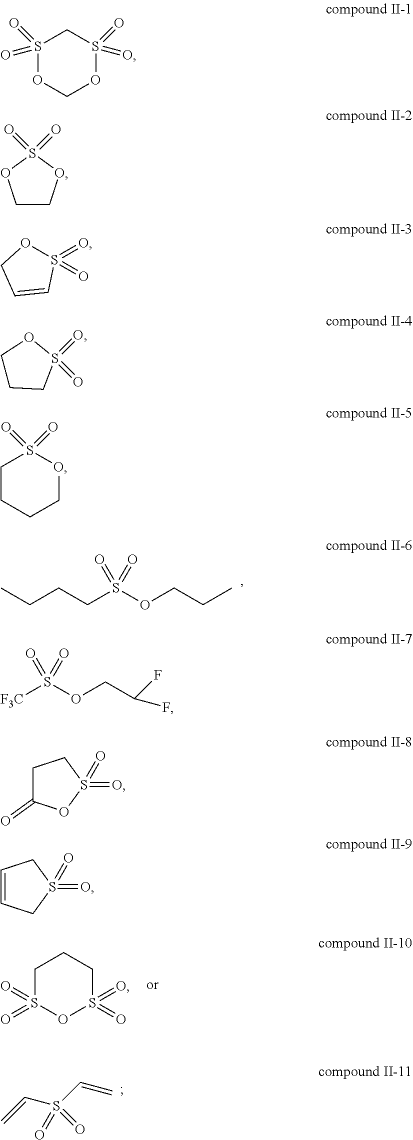

the additive D includes:
at least one of

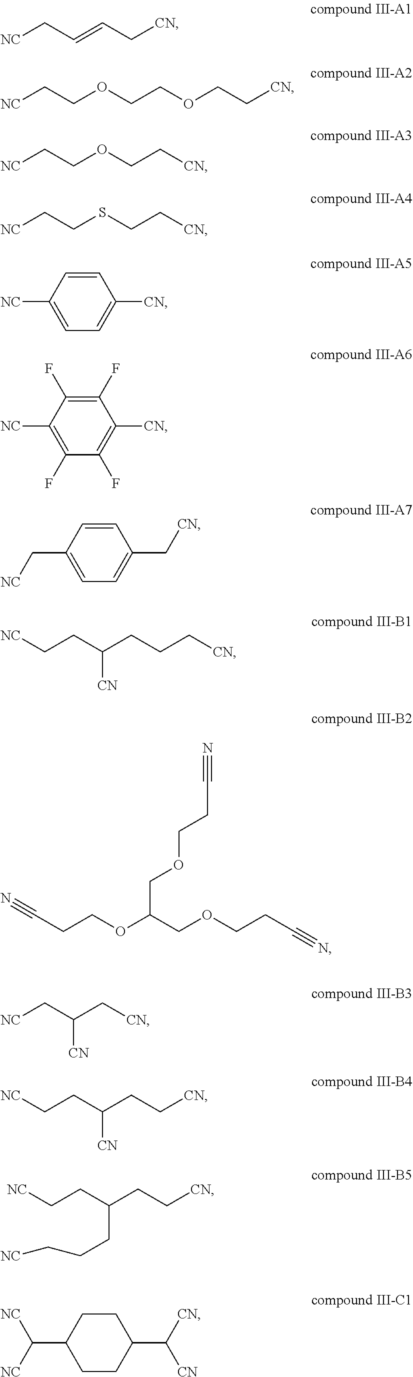

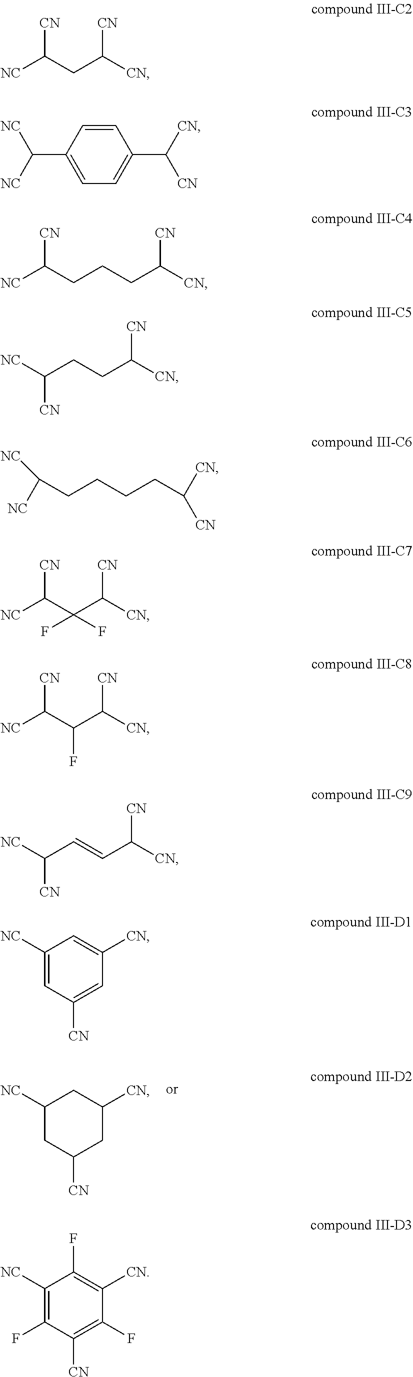

and

In some embodiments, the silicon-containing carbonate compound includes at least one of a compound represented by a formula IV-A or a compound represented by a formula IV-B:

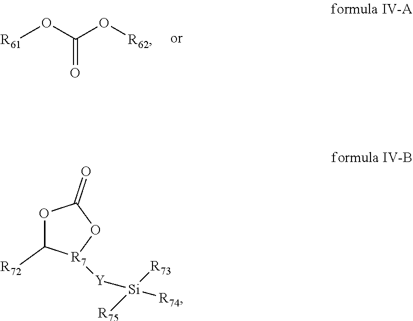

where R₆₁ and R₆₂ each are independently selected from R^{a},

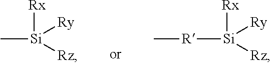

and at least one of R₆₁ and R₆₂ includes Si,
R^{a}, Rx, Ry, and Rz each are independently selected from H, a substituted or unsubstituted C₁₋₁₀ alkyl group, a substituted or unsubstituted C₂₋₁₀ alkenyl group, a substituted or unsubstituted C₆₋₁₀ cycloalkyl group, or a substituted or unsubstituted C₆₋₁₀ aryl group, where being substituted means that substitution is performed with one or more halogens,
R′ is selected from a substituted or unsubstituted C₁₋₁₂ alkylidene group or a substituted or unsubstituted C₂₋₁₂ alkenylene group, where being substituted means that substitution is performed with one or more halogens,
R₇ is

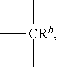

where R^{b} is selected from H, a halogen, a substituted or unsubstituted C₁₋₆ alkyl group, or a substituted or unsubstituted C₂₋₆ alkenyl group, where being substituted means that substitution is performed with one or more halogens,
Y is selected from a single bond, a substituted or unsubstituted C₁₋₄ alkylidene group, or a substituted or unsubstituted C₂₋₄ alkenylene group, where being substituted means that substitution is performed with one or more halogens,
R₇₂ is selected from H, a halogen, a substituted or unsubstituted C₁₋₆ alkyl group, a substituted or unsubstituted C₁₋₆ alkoxy group, a substituted or unsubstituted C₂₋₆ alkenyl group, or a substituted or unsubstituted C₆₋₁₀ aryl group, where being substituted means that substitution is performed with one or more substituent groups selected from a halogen, and
R₇₃, R₇₄, and R₇₅ each are independently selected from H, a substituted or unsubstituted C₁₋₆ alkyl group, a substituted or unsubstituted C₁₋₆ alkoxy group, a substituted or unsubstituted C₂₋₆ alkenyl group, or a substituted or unsubstituted C₆₋₁₀ aryl group, where being substituted means that substitution is performed with one or more substituent groups selected from a halogen, a C₁₋₆ alkyl group, or a C₂₋₆ alkenyl group; and
the additive E is 0.1% to 22% by weight with respect to the total weight of the electrolyte.

In some embodiments, the silicon-containing carbonate compound includes at least one of the following compound:

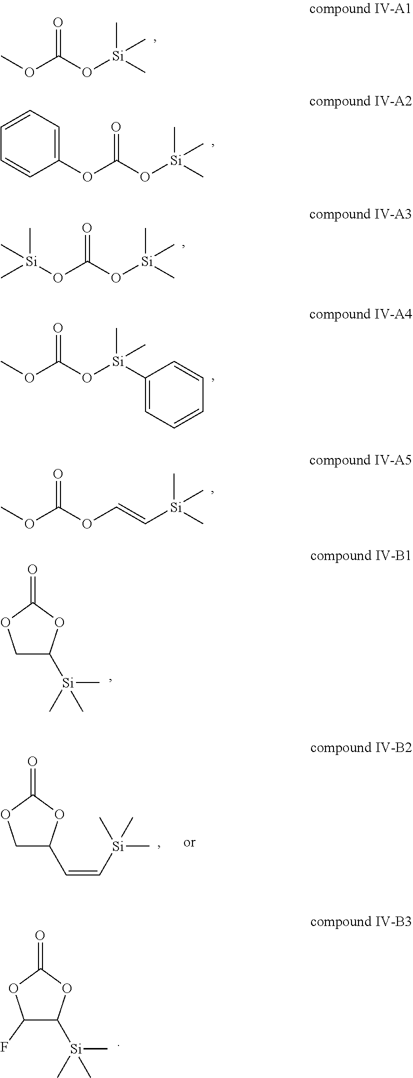

Still another aspect of the present application provides an electrochemical apparatus, including a positive electrode, a negative electrode, and any one of the foregoing electrolytes.

In some embodiments, the positive electrode includes a positive electrode active material, and particles of the positive electrode active material satisfy at least one of criteria (a) to (c):
(a) 0.4 microns≤Dv50≤20 microns;
(b) 2 microns≤Dv90≤40 microns; and
(c) the positive electrode active material includes an element A, where the element A is selected from at least one of Al, Mg, Ti, Cr, B, Fe, Zr, Y, Na, or S, and the element A is less than 0.5% by weight with respect to the total weight of the positive electrode active material.

Another aspect of the present application provides an electronic apparatus including any one of the electrochemical apparatus described above.

Additional aspects and advantages of the embodiments of this application are partially described and presented in the later description, or explained by implementation of the embodiments of this application.

### DESCRIPTION OF EMBODIMENTS

Embodiments of this application will be described in detail below. The embodiments of this application shall not be construed as limitations on the protection scope claimed by this application. Unless otherwise specified, the following terms used herein have the meanings indicated below.

The term “about” used herein is intended to describe and represent small variations. When used in combination with an event or a circumstance, the term may refer to an example in which the exact event or circumstance occurs or an example in which an extremely similar event or circumstance occurs. For example, when used in combination with a value, the term may refer to a variation range of less than or equal to ±10% of the value, for example, less than or equal to ±5%, less than or equal to ±4%, less than or equal to ±3%, less than or equal to ±2%, less than or equal to ±1%, less than or equal to ±0.5%, less than or equal to ±0.1%, or less than or equal to ±0.05%. In addition, quantities, ratios, and other values are sometimes presented in the format of ranges in this specification. It should be understood that such range formats are used for convenience and simplicity and should be flexibly understood as including not only values clearly designated as falling within the range but also all individual values or sub-ranges covered by the range as if each value and sub-range are clearly designated.

In the description of embodiments and claims, a list of items preceded by the term “one of” may mean any one of the listed items. For example, if items A and B are listed, the phrase “one of A and B” means only A or only B. In another example, if items A, B, and C are listed, the phrase “one of A, B, and C” means only A, only B, or only C. The item A may contain a single element or a plurality of elements. The item B may contain a single element or a plurality of elements. The item C may contain a single element or a plurality of elements.

In the description of embodiments and claims, a list of items preceded by the terms such as “at least one of”, at least one type of” or other similar terms may mean any combination of the listed items. For example, if items A and B are listed, the phrase “at least one of A and B” or “at least one of A or B” means only A, only B, or A and B. In another example, if items A, B, and C are listed, the phrase “at least one of A, B, and C” or “at least one of A, B, or C” means only A, only B, only C, A and B (excluding C), A and C (excluding B), B and C (excluding A), or all of A, B, and C. The item A may contain a single element or a plurality of elements. The item B may contain a single element or a plurality of elements. The item C may contain a single element or a plurality of elements.

In the description of embodiments and claims, the carbon number, namely, the number after the capital letter “C”, for example, “1”, “3” or “10” in “C₁-C₁₀” and “C₃-C₁₀”, represents the number of carbon atoms in a specific functional group. That is, the functional groups may include 1-10 carbon atoms and 3-10 carbon atoms, respectively. For example, “C₁-C₄ alkyl group” or “C₁₋₄ alkyl group” refers to an alkyl group having 1 to 4 carbon atoms, for example, CH₃—, CH₃CH₂—, CH₃CH₂CH₂—, (CH₃)₂CH—, CH₃CH₂CH₂CH₂—, CH₃CH₂CH (CH₃)—, or (CH₃)₃C—.

As used herein, the term “alkyl group” is intended to be a linear saturated hydrocarbon structure having 1 to 10 carbon atoms. The term “alkyl group” is also intended to be a branched or cyclic hydrocarbon structure having 3 to 8 carbon atoms. For example, an alkyl group may be an alkyl group having 1 to 8 carbon atoms, an alkyl group having 1 to 6 carbon atoms, an alkyl group having 1 to 5 carbon atoms, an alkyl group having 1 to 4 carbon atoms, or an alkyl group having 1 to 3 carbon atoms. References to an alkyl group with a specific carbon number are intended to cover all geometric isomers with the specific carbon number. Therefore, for example, “butyl” is meant to include n-butyl, sec-butyl, isobutyl, tert-butyl, and cyclobutyl; and “propyl” includes n-propyl, isopropyl, and cyclopropyl. Examples of alkyl groups include, but are not limited to, methyl, ethyl, n-propyl, isopropyl, cyclopropyl, n-butyl, isobutyl, sec-butyl, tert-butyl, cyclobutyl, n-pentyl, isopentyl, neopentyl, cyclopentyl, methylcyclopentyl, ethylcyclopentyl, n-hexyl, isohexyl, cyclohexyl, n-heptyl, octyl, cyclopropyl, cyclobutyl, norbornyl, and the like. In addition, the alkyl group may be arbitrarily substituted.

The term “alkenyl group” refers to a straight-chain or branched monovalent unsaturated hydrocarbon group having at least one and usually 1, 2, or 3 carbon-carbon double bonds. Unless otherwise defined, the alkenyl group generally contains 2 to 10 carbon atoms. For example, the alkenyl group may be an alkenyl group having 2 to 8 carbon atoms, an alkenyl group having 2 to 6 carbon atoms, or an alkenyl group having 2 to 4 carbon atoms. Representative alkenyl groups include, for example, vinyl, n-propenyl, isopropenyl, n-but-2-enyl, but-3-enyl, and n-hex-3-enyl. In addition, the alkenyl group may be arbitrarily substituted.

The term “alkylidene group” means a straight chain or branched chain divalent saturated hydrocarbon group. For example, the alkylidene group may be an alkylidene group having 1 to 8 carbon atoms, an alkylidene group having 1 to 6 carbon atoms, or an alkylidene group having 1 to 4 carbon atoms. Representative alkylidene groups include, for example, methylene, ethane-1,2-diyl (“ethylene”), propane-1,2-diyl, propane-1,3-diyl, butane-1,4-diyl, and pentane-1,5-diyl. In addition, the alkylidene group may be arbitrarily substituted.

The term “alkenylene group” covers straight chain and branched chain alkenylene groups. References to an alkenylene group with a specific carbon number are intended to cover all geometric isomers with the specific carbon number. For example, the alkenylene group may be an alkenylene group having 2 to 10 carbon atoms, an alkenylene group having 2 to 8 carbon atoms, an alkenylene group having 2 to 6 carbon atoms, or an alkenylene group having 2 to 4 carbon atoms. Representative alkenylene groups include, for example, vinylene, propenylene, and butenylene. In addition, the alkenylene group may be arbitrarily substituted.

The term “heterocyclic group” covers aromatic and non-aromatic cyclic groups. A heteroaromatic cyclic group also means a heteroaryl group. For example, the heterocyclic group may be a C₁₋₆ heterocyclic group or a C₁₋₄ heterocyclic group. A heteroatom of the heterocyclic group is selected from at least one of O, N, P, and S. In some embodiments, a heteroaromatic cyclic group and a non-heteroaromatic cyclic group include morpholinyl group, a piperidinyl group, a pyrrolidinyl group, and the like, and cyclic ether such as tetrahydrofuran and tetrahydropyran. In addition, the heterocyclic group may be arbitrarily substituted.

The term “aryl group” covers both monocyclic and polycyclic systems. A polycyclic ring may have two or more rings in which two carbons are shared by two adjacent rings (the rings are “fused”), where at least one of the rings is aromatic, and other rings, for example, may be a cycloalkyl group, a cycloalkenyl group, an aryl group, a heterocyclic and/or heteroaryl group. For example, the aryl group may be a C₆₋₁₂ aryl group or a C₆₋₁₀ aryl group. Representative aryl groups include, for example, phenyl, methylphenyl, propylphenyl, isopropylphenyl, benzyl, naphth-1-yl, and naphth-2-yl. In addition, the aryl group may be arbitrarily substituted.

The term “cycloalkyl group” covers cyclic alkyl groups. For example, the cycloalkyl group may be a cycloalkyl group having 3 to 12 carbon atoms, a cycloalkyl group having 3 to 10 carbon atoms, a cycloalkyl group having 3 to 8 carbon atoms, a cycloalkyl group having 3 to 6 carbon atoms, a cycloalkyl group having 3 to 5 carbon atoms, a cycloalkyl group having 5 to 7 carbon atoms, or a cycloalkyl group having 5 to 9 carbon atoms. In addition, a cyclic alkyl group may be arbitrarily substituted.

The term “cycloalkylidene group” alone or as a part of another substituent group means a divalent free radical derived from a cycloalkyl group.

The term “trivalent cycloalkyl group” alone or as a part of another substituent group means a trivalent free radical derived from a cycloalkyl group.

The term “alkoxy group” is an “alkyl-O—” group. For example, it covers an alkoxy group having 1 to 8 carbon atoms, an alkoxy group having 1 to 6 carbon atoms, an alkoxy group having 1 to 4 carbon atoms, or an alkoxy group having 5 to 8 carbon atoms. Representative examples of the alkoxy group include, but are not limited to, methoxy, ethoxy, propoxy, 2-propoxy, butoxy, tert-butoxy, pentyloxy, and hexyloxy. In addition, the alkoxy group may be arbitrarily substituted.

When the foregoing substituent groups are substituted, unless otherwise specified, they are substituted with one or more halogens.

As used herein, the term “halogen” covers F, Cl, Br, and I, and preferably, F or C₁.

Unless otherwise specified, the term “heteroatom” covers 0, S, P, N, B, or an isostere thereof.

As used herein, a content percentage of each component in the electrolyte is calculated based on a total weight of the electrolyte.

### I. ELECTROLYTE

Some embodiments of the present application provide an electrolyte. The electrolyte includes:
an additive A, where the additive A includes a non-fluorinated lithium borate compound; and
at least one additive selected from an additive B, an additive C, an additive D, or an additive E, where
the additive B includes at least one of vinylene carbonate (VC), fluoroethylene carbonate (FEC), lithium tetrafluoroborate (LiBF₄), lithium difluoro(oxalato)borate (LiODFB), or lithium difluorophosphate (LiPO₂F₂);
the additive C includes a compound including S═O;
the additive D includes a compound having 2 to 4 cyano groups; and
the additive E includes a silicon-containing carbonate compound.

In some embodiments, the non-fluorinated lithium borate compound includes at least one of a compound I-1, a compound I-2, a compound I-3, a compound I-4, or a compound I-5:

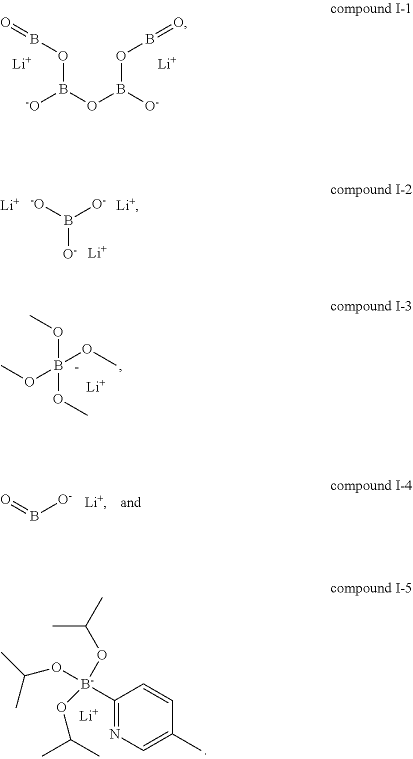

In some embodiments, based on a total weight of the electrolyte, a weight ratio of the additive A to the additive B is 1:1 to 1:200.

In some embodiments, the additive A is 0.01% to 2% by weight with respect to the total weight of the electrolyte, and the additive B is 0.1% to 10% by weight with respect to the total weight of the electrolyte.

In some embodiments, based on a total weight of the electrolyte, a weight ratio of the additive A to the additive B is 1:5 to 1:150 or 1:10 to 1:100. In some embodiments, based on a total weight of the electrolyte, a weight ratio of the additive A to the additive B is 1:1, 1:2, 1:3, 1:4, 1:5, 1:10, 1:15, 1:20, 1:25, 1:30, 1:35, 1:40, 1:45, 1:50, 1:55, 1:60, 1:65, 1:70, 1:75, 1:80, 1:85, 1:90, 1:95, 1:100, 1:105, 1:110, 1:115, 1:120, 1:125, 1:130, 1:135, 1:140, 1:145, 1:150, 1:155, 1:160, 1:165, 1:170, 1:175, 1:180, 1:185, 1:190, 1:195, or 1:200. In some embodiments, based on a total weight of the electrolyte, a weight ratio of the additive A to the additive B is 1:4, 9:20, 1:2, 1:2.1, 1:2.2, 1:2.5, 1:3, or 1:4.2.

In some embodiments, based on a total weight of the electrolyte, the additive A is 0.5% to 2% by weight, or approximately 1% to 2% by weight. In some embodiments, based on a total weight of the electrolyte, the additive A is approximately 0.01% by weight, approximately 0.05% by weight, approximately 0.1% by weight, approximately 0.2% by weight, approximately 0.3% by weight, approximately 0.4% by weight, approximately 0.5% by weight, approximately 0.6% by weight, approximately 0.7%, approximately 0.8% by weight, approximately 0.9% by weight, approximately 1% by weight, approximately 1.1% by weight, approximately 1.2% by weight, approximately 1.3% by weight, approximately 1.4% by weight, approximately 1.5% by weight, approximately 1.6% by weight, approximately 1.7% by weight, approximately 1.8% by weight, approximately 1.9% by weight, or approximately 2% by weight.

In some embodiments, based on a total weight of the electrolyte, the additive B is 1% to 8% by weight, 2% to 6% by weight, or 3% to 5% by weight. In some embodiments, based on a total weight of the electrolyte, the additive B is approximately 0.5% by weight, approximately 1% by weight, approximately 1.5% by weight, approximately 2% by weight, approximately 2.5% by weight, approximately 3% by weight, approximately 3.5% by weight, approximately 4% by weight, approximately 4.5% by weight, approximately 5% by weight, approximately 5.5% by weight, approximately 6% by weight, approximately 6.5% by weight, approximately 7% by weight, approximately 7.5% by weight, approximately 8% by weight, approximately 8.5% by weight, approximately 9% by weight, or approximately 9.5% by weight. In some embodiments, based on a total weight of the electrolyte, the additive B is approximately 2% by weight, approximately 2.1% by weight, approximately 2.2% by weight, approximately 2.5% by weight, approximately 3% by weight, approximately 4% by weight, or approximately 4.2% by weight.

In some embodiments, the additive B includes lithium difluorophosphate (LiPO₂F₂), where based on a total weight of the electrolyte, a weight ratio of the additive A to the lithium difluorophosphate is 10:1 to 1:1, and the lithium difluorophosphate is 0.01% to 1% by weight with respect to the total weight of the electrolyte.

In some embodiments, the additive B includes lithium difluorophosphate, where based on a total weight of the electrolyte, a weight ratio of the additive A to the lithium difluorophosphate is 10:1, 9:1, 8:1, 7:1, 6:1, 5:1, 4:1, 10:3, 3:1, 2:1 or 1:1, and the lithium difluorophosphate is approximately 0.02% by weight, Approximately 0.05% by weight, approximately 0.1% by weight, approximately 0.2% by weight, approximately 0.3% by weight, approximately 0.4% by weight, approximately 0.5% by weight, approximately 0.6% by weight, approximately 0.7% by weight, approximately 0.8% by weight, approximately 0.9% by weight, or approximately 1% by weight.

In some embodiments, the additive C includes at least one of a compound represented by a formula II-A, a compound represented by a formula II-B, a compound represented by a formula II-C, or a compound represented by a formula II-D:

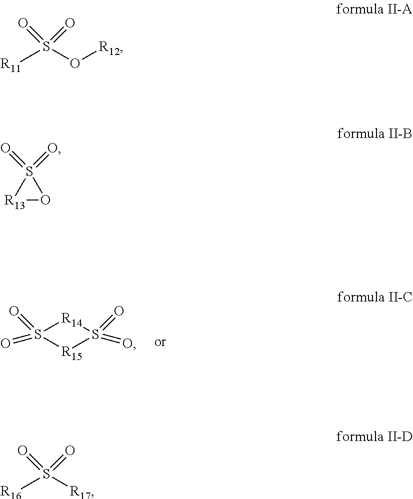

where
R₁₁ and R₁₂ each are independently selected from a substituted or unsubstituted C₁₋₁₀ alkyl group, a substituted or unsubstituted C₂₋₁₀ alkenyl group, a substituted or unsubstituted C₆₋₁₀ aryl group, or a substituted or unsubstituted C₁₋₆ heterocyclic group, where when substitution is performed, a substituent group is one or more of a halogen, a nitro group, a cyano group, or a carboxyl group, and a heteroatom of the heterocyclic group is selected from at least one of O, N, P, and S;
R₁₃ is selected from a substituted or unsubstituted C₁₋₄ alkylidene group, a substituted or unsubstituted C₂₋₄ alkenylene group, or a substituted and unsubstituted C₁₋₆ linear alkane including 1 to 5 heteroatoms, where when substitution is performed, a substituent group is selected from an oxy group, a halogen, a C₁₋₃ alkyl group, or a C₂₋₄ alkenyl group, and the heteroatom is selected from O, N, P or S;
R₁₄ and R₁₅ each are independently selected from O, a substituted or unsubstituted C₁₋₄ alkylidene group, a substituted or unsubstituted C₂₋₄ alkenylene group, or a substituted and unsubstituted C₁₋₆ linear alkane including 1 to 5 heteroatoms, where being substituted means that substitution is performed with one or more substituent groups selected from a halogen, a C₁₋₃ alkyl group, or a C₂₋₄ alkenyl group, and the heteroatom is selected from O, N, P or S, and
R₁₆ and R₁₇ each are independently selected from a substituted or unsubstituted C₁₋₄ alkyl group or a substituted or unsubstituted C₂₋₄ alkenyl group; or R₁₆ and R₁₇ are connected together to form a saturated/unsaturated and substituted/unsubstituted ring including 3 to 6 carbons, where being substituted means that substitution is performed with one or more substituent groups selected from a halogen, a C₁₋₃ alkyl group, or a C₂₋₄ alkenyl group; and
the additive C is 0.1% to 10% by weight with respect to the total weight of the electrolyte.

In some embodiments, the additive D includes at least one of a compound represented by a formula III-A, a compound represented by a formula III-B, a compound represented by a formula III-C, or a compound represented by a formula III-D:

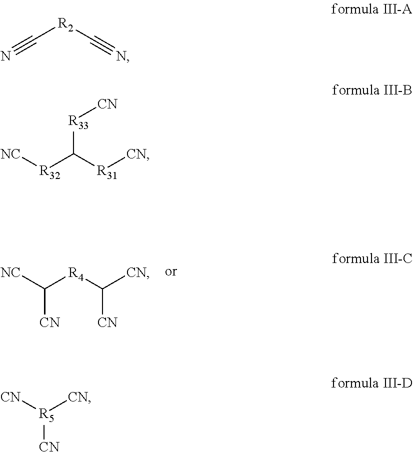

where
R₂ is selected from a C₂₋₁₀ alkenylene group, a C₆₋₁₂ cycloalkylidene group, a C₆₋₁₂ arylene group, —R₀—C₆₋₁₂ arylene-R—, —R₀—S—R—, or —R₀—(O—R)ₙ—,
R₃₁, R₃₂, and R₃₃ each are independently selected from a single bond, a C₁₋₆ alkylidene group, —R₀—(O—R)ₙ—, or —O—R—,
R₄ is selected from a C₁₋₁₀ alkylidene group, a C₂₋₁₀ alkenylene group, a C₆₋₁₂ cycloalkylidene group, a C₆₋₁₂ arylene group, —R₀—S—R—, or —R₀—(O—R)ₙ—,
R₅ is selected from a C₆₋₁₂ trivalent cycloalkyl group or a C₆₋₁₂ trivalent aryl group, where the C₆₋₁₂ trivalent cycloalkyl group or C₆₋₁₂ trivalent aryl group is arbitrarily substituted with 1 to 3 substituent groups selected from a halogen,
R₀ and R each are independently a C₁₋₄ alkylidene group, and
R₂, R₄, R₀, and R each are unsubstituted or substituted with one or more substituent groups selected from a halogen, where
n is a natural number from 0 to 3; and
the additive D is 0.1% to 12% by weight with respect to the total weight of the electrolyte.

In some embodiments, R₁₁ and R₁₂ each are independently selected from the following substituted or unsubstituted group: a C₁₋₈ alkyl group, a C₁₋₆ alkyl group, a C₁₋₄ alkyl group, a C₂₋₈ alkenyl group, a C₂₋₆ alkenyl group, a C₂₋₄ alkenyl group, a C₆₋₈ aryl group, a C₁₋₅ heterocyclic group, a C₁₋₄ heterocyclic group, or a C₁₋₃ heterocyclic group, where being substituted means that substitution is performed with one or more halogens, and a heteroatom of the heterocyclic group is selected from at least one of O, N, P, and S.

In some embodiments, R₁₁ and R₁₂ each are independently selected from the following substituted or unsubstituted group: a methyl group, an ethyl group, a propyl group, or a butyl group, where being substituted means that substitution is performed with one or more Fs. In some embodiments, R₁₁ and R₁₂ each are independently selected from —CF₃, —CH₂CH₂F₂, a methyl group, an ethyl group, a propyl group, or a butyl group.

In some embodiments, R₁₃ is selected from the following substituted or unsubstituted group: a C₁₋₃ alkylidene group, a C₁₋₂ alkylidene group, a C₂₋₃ alkenylene group, or a C₁₋₆ linear alkane including 1 to 3 heteroatoms, where when substitution is performed, a substituent group is selected from an oxy group, a halogen, a C₁₋₃ alkyl group, or a C₂₋₄ alkenyl group, and the heteroatom is selected from O or S.

In some embodiments, R₁₃ is selected from the following substituted or unsubstituted group: a propylene group, a butylene group, a propenylene group, a butenylene group, or a C₁₋₄ linear alkane including 1 to 2 heteroatoms, where when substitution is performed, a substituent group is selected from an oxy group or F, and the heteroatom is selected from O.

In some embodiments, R₁₄ and R₁₅ each are independently selected from or the following substituted or unsubstituted group: a C₁₋₄ alkylidene group, a C₂₋₄ alkenylene group, or a C₁₋₆ linear alkane including 1 to 3 heteroatoms, where being substituted means that substitution is performed with one or more substituent groups selected from a halogen, a C₁₋₃ alkyl group, or a C₂₋₄ alkenyl group, and the heteroatom is selected from O or S.

In some embodiments, R₁₄ and R₁₅ each are independently selected from or the following substituted or unsubstituted group: a methylene group, an ethylene group, a propylene group, or —O—CH₂—, where being substituted means that substitution is performed with one or more substituent groups selected from F.

In some embodiments, R₁₆ and R₁₇ each are independently selected from the following substituted or unsubstituted group: a C₁₋₃ alkyl group or a C₂₋₃ alkenyl group; or R₁₆ and R₁₇ are connected together to form a saturated/unsaturated and substituted/unsubstituted ring including 3 or 4 carbons, where being substituted means that substitution is performed with one or more substituent groups selected from a halogen.

In some embodiments, R₁₆ and R₁₇ each are independently selected from the following substituted or unsubstituted group: a methyl group, an ethyl group, a vinyl group, or a propenyl group; or R₁₆ and R₁₇ are connected together to form a saturated/unsaturated and substituted/unsubstituted ring including 3 or 4 carbons, where being substituted means that substitution is performed with one or more F atoms.

In some embodiments, R₂ is selected from the following substituted or unsubstituted group: a C₂₋₈ alkenylene group, a C₂₋₆ alkenylene group, a C₂₋₄ alkenylene group, a C₆₋₁₀ cycloalkylidene group, a C₆₋₈ cycloalkylidene group, a C₆₋₁₀ arylene group, a C₆₋₈ arylene group, —R₀—C₆₋₁₀ arylene-R—, —R₀—C₆₋₈ arylene-R—, —R₀—S—R—, or —R₀—(O—R)ₙ—, where R₀ and R each are independently selected from a substituted or unsubstituted C₁₋₄ alkylidene group, where being substituted means that substitution is performed with one or more halogens, and n is selected from 0, 1, 2, or 3.

In some embodiments, R₂ is selected from the following substituted or unsubstituted group: a C₂₋₄ alkenylene group, a C₆ cycloalkylidene group, a phenylene group, —R₀-phenylene-R—, —R₀—S—R—, or —R₀—(O—R)ₙ—, where R₀ and R each are independently a substituted or unsubstituted methylene or ethylene group, where being substituted means that substitution is performed with one or more F atoms, and n is selected from 0, 1, or 2.

In some embodiments, R₃₁, R₃₂, and R₃₃ each are independently selected from a single bond and the following substituted or unsubstituted group: a C₁₋₄ alkylidene group, —R₀—(O—R)ₙ—, or —O—R—, where R₀ and R each are independently a substituted or unsubstituted C₁₋₄ alkylidene group, where being substituted means that substitution is performed with one or more F atoms, and n is selected from 0, 1, or 2.

In some embodiments, R₃₁, R₃₂, and R₃₃ each are independently selected from a single bond and the following substituted or unsubstituted group: a methylene group, an ethyl group, a propylene group, —R₀—(O—R)ₙ—, or —O—R—, where R₀ and R each are independently a substituted or unsubstituted methylene or ethylene group, where being substituted means that substitution is performed with one or more F atoms, and n is selected from 0, 1, or 2.

In some embodiments, R₄ is selected from the following substituted or unsubstituted group: a C₁₋₈ alkylidene group, a C₁₋₆ alkylidene group, a C₁₋₄ alkylidene group, a C₂₋₈ alkenylene group, a C₂₋₆ alkenylene group, a C₂₋₄ alkenylene group, a C₆₋₁₀ cycloalkylidene group, a C₆₋₈ cycloalkylidene group, a C₆₋₁₀ arylene group, a C₆₋₈ arylene group, —R₀—S—R—, or —R₀—(O—R)ₙ—, where R₀ and R each are independently selected from a substituted or unsubstituted C₁₋₄ alkylidene group, where being substituted means that substitution is performed with one or more F atoms, and n is selected from 0, 1, 2, or 3.

In some embodiments, R₄ is selected from the following substituted or unsubstituted group: a methylene group, an ethylene group, a propylene group, a butylene group, a vinylene group, C₆-cycloalkylidene, a phenylene group, —R₀—S—R—, or —R₀—(O—R)ₙ—, where R₀ and R each are independently a substituted or unsubstituted C₁₋₂ alkylidene group, where being substituted means that substitution is performed with one or more F atoms, and n is selected from 0, 1, or 2.

In some embodiments, R₄ is selected from the following substituted or unsubstituted group: a methylene group, an ethylene group, a propylene group, a butylene group, a vinylene group, —CF₂—, —CHF—, C₆-cycloalkylidene, or a phenylene group, where being substituted means that substitution is performed with one or more F atoms.

In some embodiments, R₅ is selected from the following substituted or unsubstituted group: a C₆₋₁₀ trivalent cycloalkyl group, a C₆₋₈ trivalent cycloalkyl group, a C₆₋₁₀ trivalent aryl group, or a C₆₋₈ trivalent aryl group, where being substituted means that substitution is performed with 1 to 3 substituent groups selected from a halogen.

In some embodiments, R₅ is selected from the following substituted or unsubstituted groups: a C₆ trivalent cycloalkyl group and a trivalent phenyl group, where being substituted means that substitution is performed with 1 to 3 F atoms.

In some embodiments, based on a total weight of the electrolyte, the additive C is 0.3% to 8% by weight or 0.5% to 6% by weight. In some embodiments, based on a total weight of the electrolyte, the additive C is approximately 0.1% by weight, approximately 0.2% by weight, approximately 0.3% by weight, approximately 0.4% by weight, approximately 0.5% by weight, approximately 0.6% by weight, approximately 0.7% by weight, approximately 0.8% by weight, approximately 0.9% by weight, approximately 1% by weight, approximately 1.5% by weight, approximately 2% by weight, approximately 2.5% by weight, approximately 3% by weight, approximately 3.5% by weight, approximately 4% by weight, approximately 4.5% by weight, approximately 5% by weight, approximately 5.5% by weight, approximately 6% by weight, approximately 6.5% by weight, approximately 7% by weight, approximately 7.5% by weight, approximately 8% by weight, approximately 8.5% by weight, approximately 9% by weight, approximately 9.5% by weight, or approximately 10% by weight.

In some embodiments, based on a total weight of the electrolyte, the additive D is 0.5% to 10% by weight or 1% to 8% by weight. In some embodiments, based on a total weight of the electrolyte, the additive D is approximately 0.1% by weight, approximately 0.2% by weight, approximately 0.3% by weight, approximately 0.4% by weight, approximately 0.5% by weight, approximately 0.6% by weight, approximately 0.7% by weight, approximately 0.8% by weight, approximately 0.9% by weight, approximately 1% by weight, approximately 1.5% by weight, approximately 2% by weight, approximately 2.5% by weight, approximately 3% by weight, approximately 3.5% by weight, approximately 4% by weight, approximately 4.5% by weight, approximately 5%, approximately 5.5%, approximately 6% by weight, approximately 6.5% by weight, approximately 7% by weight, approximately 7.5% by weight, approximately 8% by weight, approximately 8.5% by weight, approximately 9% by weight, approximately 9.5% by weight, approximately 10% by weight, approximately 10.5% by weight, approximately 11% by weight, approximately 11.5% by weight, or approximately 12% by weight.

In some embodiments, the additive C includes at least one of the following compound:

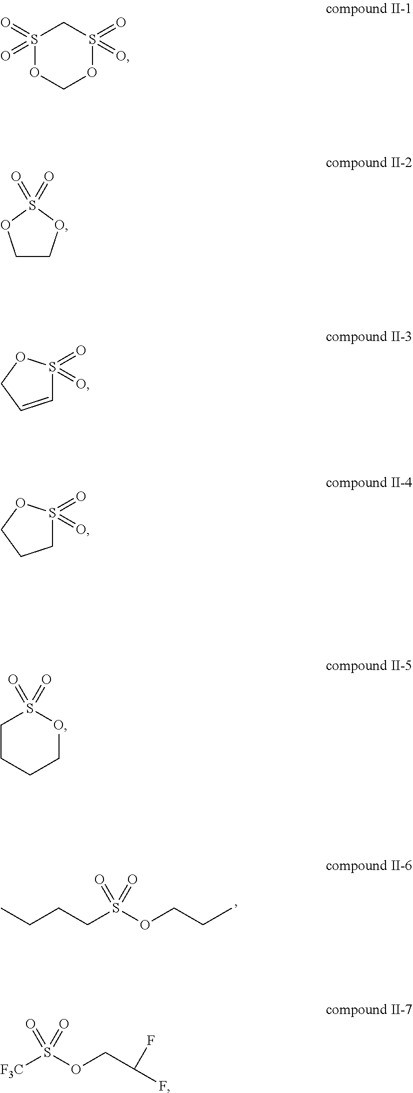

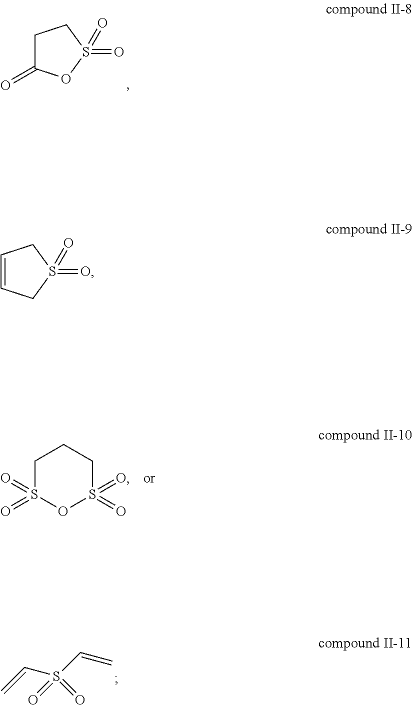

and
the additive D includes at least one of the following compound:

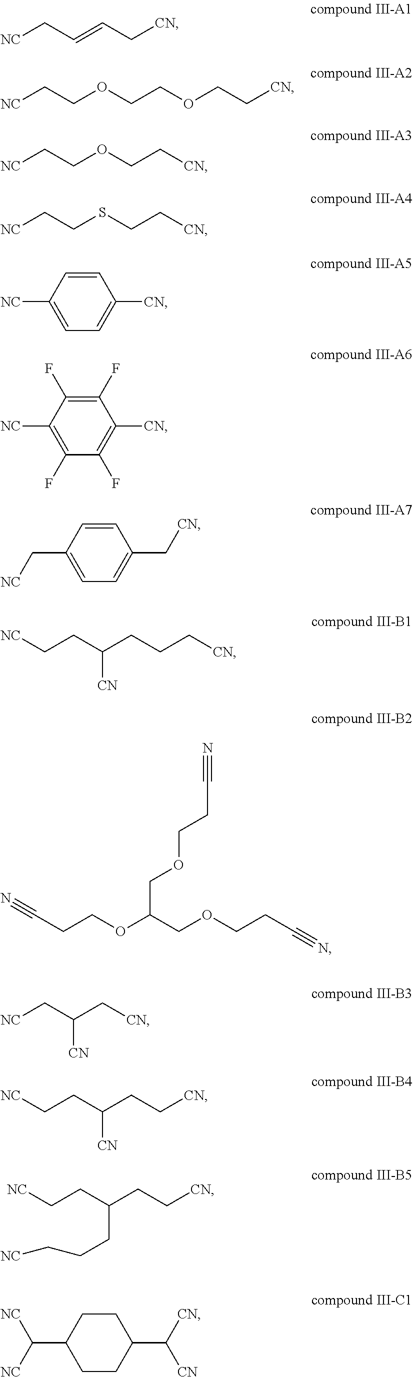

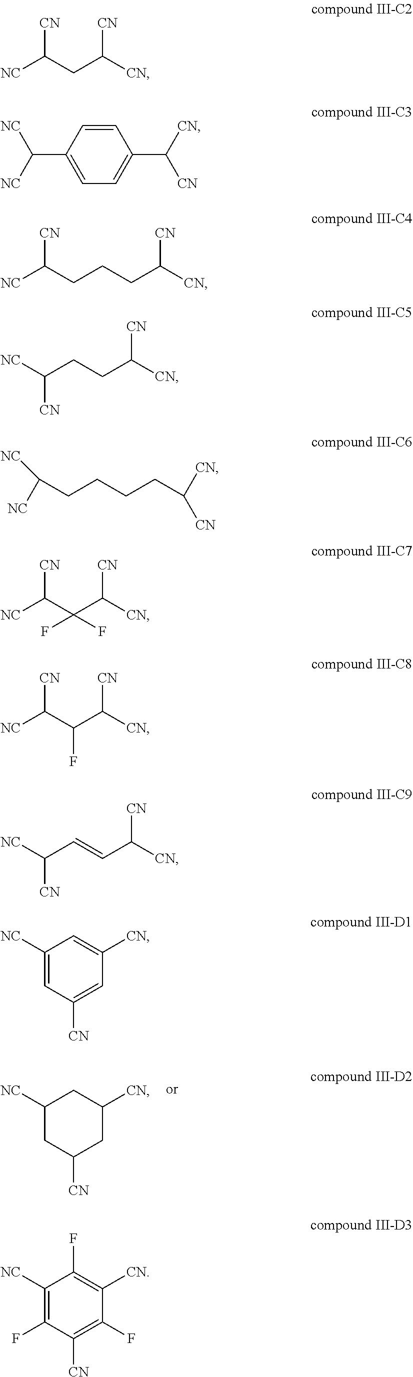

In some embodiments, the silicon-containing carbonate compound includes at least one of a compound represented by a formula IV-A or a compound represented by a formula IV-B:

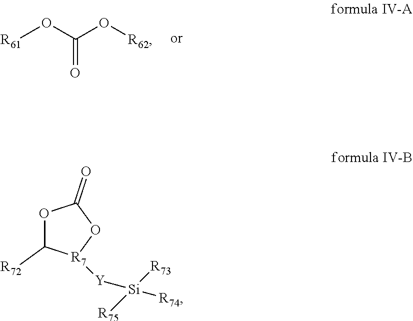

where R₆₁ and R₆₂ each are independently selected from R^{a},

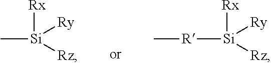

and at least one of R₆₁ and R₆₂ includes Si,
R^{a}, Rx, Ry, and Rz each are independently selected from H, a substituted or unsubstituted C₁₋₁₀ alkyl group, a substituted or unsubstituted C₂₋₁₀ alkenyl group, a substituted or unsubstituted C₆₋₁₀ cycloalkyl group, or a substituted or unsubstituted C₆₋₁₀ aryl group, where being substituted means that substitution is performed with one or more halogen atoms,
R′ is selected from a substituted or unsubstituted C₁₋₁₂ alkylidene group or a substituted or unsubstituted C₂₋₁₂ alkenylene group, where being substituted means that substitution is performed with one or more halogen atoms,
R₇ is

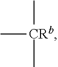

where R^{b} is selected from H, a halogen, a substituted or unsubstituted C₁₋₆ alkyl group, or a substituted or unsubstituted C₂₋₆ alkenyl group, where being substituted means that substitution is performed with one or more halogen atoms,
Y is selected from a single bond, a substituted or unsubstituted C₁₋₄ alkylidene group, or a substituted or unsubstituted C₂₋₄ alkenylene group, where being substituted means that substitution is performed with one or more halogen atoms,
R₇₂ is selected from H, a halogen, a substituted or unsubstituted C₁₋₆ alkyl group, a substituted or unsubstituted C₁₋₆ alkoxy group, a substituted or unsubstituted C₂₋₆ alkenyl group, or a substituted or unsubstituted C₆₋₁₀ aryl group, where being substituted means that substitution is performed with one or more substituent groups selected from a halogen, and
R₇₃, R₇₄, and R₇₅ each are independently selected from H, a substituted or unsubstituted C₁₋₆ alkyl group, a substituted or unsubstituted C₁₋₆ alkoxy group, a substituted or unsubstituted C₂₋₆ alkenyl group, or a substituted or unsubstituted C₆₋₁₀ aryl group, where being substituted means that substitution is performed with one or more substituent groups selected from a halogen, a C₁₋₆ alkyl group, or a C₂₋₆ alkenyl group; and
the additive E is 0.1% to 22% by weight with respect to the total weight of the electrolyte.

In some embodiments, R₆₁ and R₆₂ each are independently selected from R^{a},

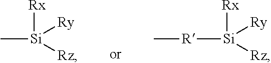

and at least one of R₆₁ and R₆₂ includes Si;
R^{a}, Rx, Ry, and Rz each are independently selected from H and the following substituted or unsubstituted group: a C₁₋₈ alkyl group, a C₁₋₆ alkyl group, a C₁₋₄ alkyl group, a C₂₋₈ alkenyl group, a C₂₋₆ alkenyl group, a C₂₋₄ alkenyl group, a C₆₋₈ cycloalkyl group, or a C₆₋₈ aryl group, where being substituted means that substitution is performed with one or more halogen atoms.

In some embodiments, R′ is selected from the following substituted or unsubstituted group: a C₁₋₈ alkylidene group, a C₁₋₆ alkylidene group, a C₁₋₄ alkylidene group, a C₂₋₁₀ alkenylene group, a C₂₋₈ alkenylene group, a C₂₋₆ alkenylene group, or a C₂₋₄ alkenylene group, where being substituted means that substitution is performed with one or more halogen atoms.

In some embodiments, R₆₁ and R₆₂ each are independently selected from the following substituted or unsubstituted group: a methyl group, an ethyl group, a phenyl group,

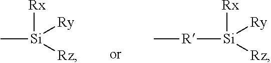

and at least one of R₆₁ and R₆₂ includes Si, where Rx, Ry, and Rz each are independently selected from H, the following unsubstituted group, or the following group substituted with one or more F atoms: a methyl group, an ethyl group, or a phenyl group; R′ is selected from the following unsubstituted group or the following group substituted with one or more Fs: a methyl group, an ethyl group, or a vinyl group.

In some embodiments, R₇ is

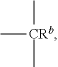

where R^{b} is selected from H, a halogen, the following unsubstituted group, or the following group substituted with one or more F atoms: a C₁₋₄ alkyl group or a C₂₋₄ alkenyl group. In some embodiments, R^{b} is selected from H, F, an unsubstituted methyl group, or a methyl group substituted with one or more F atoms

In some embodiments, R₇₂ is selected from H, a halogen, or the following substituted or unsubstituted group: a C₁₋₄ alkyl group, a C₁₋₄ alkoxy group, a C₂₋₄ alkenyl group, or a C₆₋₈ aryl group, where being substituted means that substitution is performed with one or more substituent groups selected from a halogen. In some embodiments, R₇₂ is selected from H, F, or an unsubstituted methyl or ethyl group, or a methyl or ethyl group substituted with one or more F atoms.

In some embodiments, Y is selected from a single bond or the following substituted or unsubstituted group: a methylene group, an ethylene group, a vinylene group, or a propenylene group, where being substituted means that substitution is performed with one or more F atoms.

In some embodiments, R₇₃, R₇₄, and R₇₅ each are independently selected from H or the following substituted or unsubstituted group: a C₁₋₄ alkyl group, a C₁₋₄ alkoxy group, a C₂₋₄ alkenyl group, or a C₆₋₈ aryl group, where being substituted means that substitution is performed with one or more substituent groups selected from a halogen, a C₁₋₄ alkyl group, or a C₂₋₄ alkenyl group.

In some embodiments, R₇₃, R₇₄, and R₇₅ each are independently selected from H, an unsubstituted methyl or ethyl group, or a methyl or ethyl group substituted with one or more F atoms.

In some embodiments, based on a total weight of the electrolyte, the additive E is 1% to 20% by weight, 3% to 18% by weight, or 5% to 15% by weight. In some embodiments, based on a total weight of the electrolyte, the additive E is approximately 0.5% by weight, approximately 1% by weight, approximately 2% by weight, approximately 3% by weight, approximately 4% by weight, approximately 5% by weight, approximately 6% by weight, Approximately 7% by weight, approximately 8% by weight, approximately 9% by weight, approximately 10% by weight, approximately 11% by weight, approximately 12% by weight, approximately 13% by weight, approximately 14% by weight, approximately 15% by weight, approximately 16% by weight, approximately 17% by weight, approximately 18% by weight, approximately 19% by weight, or approximately 20% by weight.

In some embodiments, the silicon-containing carbonate compound is at least one of the following compound:

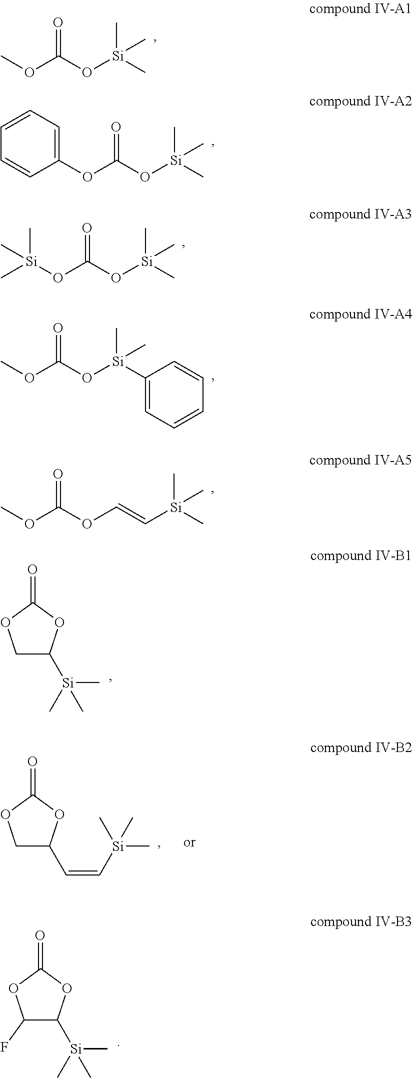

In some embodiments, the electrolyte further includes a lithium salt and an organic solvent.

In some embodiments, the lithium salt includes or is selected from at least one of an organic lithium salt or an inorganic lithium salt. In some embodiments, the lithium salt of this application contains at least one of fluorine, boron, and phosphorus.

In some embodiments, the lithium salt is selected from one or more of lithium hexafluorophosphate (LiPF₆), lithium hexafluoroarsenate, lithium perchlorate, lithium bis(fluorosulfonyl)imide (LiFSI), lithium bis(trifluoromethanesulfonyl)imide (LiTFSI), and lithium bis(oxalate)borate (LiBOB). More preferably, the lithium salt is selected from lithium hexafluorophosphate (LiPF₆).

In some embodiments, a concentration of the lithium salt in the electrolyte of this application is: 0.6 mol/L to 2 mol/L or 0.8 mol/L to 1.2 mol/L.

A specific type of the organic solvent is not limited. In some embodiments, the organic solvent may include linear carbonate, cyclic carbonate, linear carboxylate, cyclic carboxylate, ether, and the like. For example, the organic solvent may include one or more of dimethyl carbonate, ethyl methyl carbonate, methyl propyl carbonate, methyl isopropyl carbonate, methyl butyl carbonate, diethyl carbonate, dipropyl carbonate, dibutyl carbonate, ethylene carbonate, propylene carbonate, butylene carbonate, methyl acetate, ethyl acetate, propyl acetate, butyl acetate, methyl propionate, ethyl propionate, propyl propionate, butyl propionate, methyl butyrate, ethyl butyrate, propyl butyrate, methyl valerate, ethyl valerate, methyl pivalate, ethyl pivalate, butyl pivalate, γ-butyrolactone, and γ-valerolactone.

According to the embodiments of this application, the non-aqueous organic solvent in the electrolyte may be a single non-aqueous organic solvent or a mixture of multiple non-aqueous organic solvents. When a mixed solvent is used, proportions of solvents may be controlled based on desired performance of the electrochemical apparatus.

In some embodiments, the organic solvent accounts for approximately 70 wt % to approximately 95 wt % of the electrolyte.

### II. ELECTROCHEMICAL APPARATUS

The electrochemical apparatus according to this application includes any apparatus in which electrochemical reactions take place. Specific examples of the apparatus include all kinds of primary batteries, secondary batteries, fuel batteries, solar batteries, or capacitors. Especially, the electrochemical apparatus is a lithium secondary battery, including lithium metal secondary batteries, lithium-ion secondary batteries, lithium polymer secondary batteries, or lithium-ion polymer secondary batteries. In some embodiments, the electrochemical apparatus according to this application is an electrochemical apparatus provided with a positive electrode having a positive electrode active substance capable of occluding and releasing metal ions, and a negative electrode having a negative electrode active substance capable of occluding and releasing metal ions. The electrochemical apparatus includes any one of the foregoing electrolytes in this application.

Electrolyte

The electrolyte used in the electrochemical apparatus according to this application is any one of the foregoing electrolytes in this application. In addition, the electrolyte used in the electrochemical apparatus according to this application may also include other electrolytes within the scope without departing from the essence of this application.

Negative Electrode

A negative electrode of the electrochemical apparatus according to the embodiments of this application includes a current collector and a negative electrode active substance layer formed on the current collector. The negative electrode active material is not limited to a specific type, and may be selected based on needs. The negative electrode active substance layer includes a negative electrode active substance, and the negative electrode active substance may include a material that reversibly intercalates or deintercalates a lithium ion, lithium metal, a lithium metal alloy, a material capable of doping or dedoping lithium, or a transition metal oxide.

The material that reversibly intercalates and deintercalates a lithium ion may be a carbon material. The carbon material may be any carbon-based negative electrode active substance commonly used in a lithium-ion rechargeable electrochemical apparatus. Examples of the carbon material include crystalline carbon, amorphous carbon, and combinations thereof. The crystalline carbon may be amorphous or plate-shaped, flake-shaped, spherical or fiber-shaped natural graphite or artificial graphite. The amorphous carbon may be soft carbon, hard carbon, a mesophase pitch carbonization product, burnt coke, or the like. Both low crystalline carbon and high crystalline carbon can be used as the carbon material. The low crystalline carbon material may generally include soft carbon and hard carbon. The high crystalline carbon material may generally include natural graphite, crystalline graphite, pyrolytic carbon, a mesophase pitch-based carbon fiber, mesophase carbon microbeads, mesophase pitch, and high-temperature calcined carbon (such as petroleum or coke derived from coal tar pitch).

In some embodiments, the negative electrode active material is selected from one or more of natural graphite, artificial graphite, mesocarbon microbeads (MCMB for short), hard carbon, soft carbon, silicon, a silicon-carbon composite, a Li—Sn alloy, a Li—Sn—O alloy, Sn, SnO, SnO₂, spinel-structure lithiated TiO₂—Li₄Ti₅O₁₂, and a Li—Al alloy.

The negative electrode active substance layer includes a binder, and the binder may include various binder polymers, for example, polyvinyl alcohol, carboxymethyl cellulose, hydroxypropyl cellulose, diacetyl cellulose, polyvinyl chloride, carboxylated polyvinyl chloride, polyvinyl fluoride, polyvinylpyrrolidone, polyurethane, polytetrafluoroethylene, poly(vinylidene fluoride), polyethylene, polypropylene, styrene-butadiene rubber, acrylic styrene-butadiene rubber, epoxy resin, and nylon.

The negative electrode active substance layer further includes a conductive material to improve electrode conductivity. Any conductive material that causes no chemical change can be used as the conductive material. Examples of the conductive material include: a carbon-based material such as natural graphite, artificial graphite, carbon black, acetylene black, Ketjen black, and carbon fiber; a metal-based material such as metal powder or metal fiber including copper, nickel, aluminum, silver; a conductive polymer such as a polyphenylene derivative; or any mixture thereof.

The current collector may be copper foil, nickel foil, stainless steel foil, titanium foil, nickel foam, copper foam, a polymer substrate coated with a conductive metal, or a combination thereof.

In some embodiments, the current collector includes, but is not limited to, copper foil, nickel foil, stainless steel foil, titanium foil, nickel foam, copper foam, a polymer substrate coated with a conductive metal, and any combination thereof.

The negative electrode can be prepared by using a preparation method known in the art. For example, the negative electrode may be obtained by using the following method: mixing an active material, a conductive material, and a binder in a solvent to prepare an active material composition, and applying the active material composition on a current collector.

Positive Electrode

A positive electrode of the electrochemical apparatus according to the embodiments of this application includes a current collector and a positive electrode active material layer provided on the current collector.

In some embodiments, the positive electrode active material includes a compound that reversibly intercalates and deintercalates a lithium ion (namely, a lithiated intercalation compound).

The positive electrode active material may include a composite oxide. The composite oxide includes lithium and at least one element selected from cobalt, manganese, and nickel.

Specific types of the positive electrode active material are not subject to specific restrictions, and can be selected as required. Specifically, the positive electrode active material is selected from one or more of a lithium cobalt oxide (LiCoO₂), a lithium-nickel-cobalt-manganese ternary material, a lithium manganate oxide (LiMn₂O₄), a lithium nickel manganese oxide (LiNi_{0.5}Mn_{1.5}O₄), and lithium iron phosphate (LiFePO₄).

In some embodiments, the positive electrode active material layer further includes a binder, and optionally, further includes a conductive material. The binder enhances binding between particles of the positive electrode active material, and binding between the positive electrode active material and the current collector. Non-limiting examples of the binder include polyvinyl alcohol, hydroxypropyl cellulose, diacetyl cellulose, polyvinyl chloride, carboxylated polyvinyl chloride, polyvinyl fluoride, polyvinylpyrrolidone, polyurethane, polytetrafluoroethylene, poly(vinylidene fluoride), polyethylene, polypropylene, styrene-butadiene rubber, acrylic styrene-butadiene rubber, epoxy resin, nylon, and the like.

In some embodiments, the conductive material imparts conductivity to the electrode. The conductive material may include any conductive material that causes no chemical change. Non-limiting examples of the conductive material include: a carbon-based material (for example, natural graphite, artificial graphite, carbon black, acetylene black, Ketjen black, and carbon fiber), a metal-based material (for example, metal powder, and metal fiber, including copper, nickel, aluminum, silver, and the like), a conductive polymer (for example, a polyphenylene derivative), and any mixture thereof.

The current collector may be, but is not limited to, aluminum (Al).

The positive electrode can be prepared by a preparation method known in the art. For example, the positive electrode may be obtained by using the following method: mixing the active material, the conductive material, and the binder in a solvent to prepare an active material composition, and applying the active material composition on the current collector. In some embodiments, the solvent may include, but is not limited to, N-methylpyrrolidone and the like.

In some embodiments, the positive electrode includes a positive electrode active material, and particles of the positive electrode active material satisfy at least one of criteria (a) to (c):
(a) 0.4 microns≤Dv50≤20 microns;
(b) 2 microns≤Dv90≤40 microns; and
(c) the positive electrode active material includes an element A, where the element A is selected from at least one of Al, Mg, Ti, Cr, B, Fe, Zr, Y, Na, or S, and a content percentage of the element A is less than 0.5% by weight with respect to the total weight of the positive electrode active material.

Separator

In some embodiments, the electrochemical apparatus according to this application has a separator provided between the positive electrode and the negative electrode to prevent short circuits. The separator used in the electrochemical apparatus according to this application is not particularly limited to any material or shape, and may be based on any technology disclosed in the prior art. In some embodiments, the separator includes a polymer or an inorganic substance formed by a material stable to the electrolyte of this application.

For example, the separator may include a substrate layer and a surface treatment layer. The substrate layer is a non-woven fabric, a membrane, or a composite membrane having a porous structure, and a material of the substrate layer is selected from at least one of polyethylene, polypropylene, polyethylene terephthalate, and polyimide. Specifically, a polypropylene porous membrane, a polyethylene porous membrane, a polypropylene non-woven fabric, a polyethylene non-woven fabric or a polypropylene-polyethylene-polypropylene porous composite membrane can be selected.

The surface treatment layer is provided on at least one surface of the substrate layer, and the surface treatment layer may be a polymer layer or an inorganic layer, or may be a layer formed by a mixed polymer and an inorganic substance.

The inorganic layer includes inorganic particles and a binder. The inorganic particles are selected from one or a combination of aluminum oxide, silicon oxide, magnesium oxide, titanium oxide, hafnium oxide, tin oxide, ceria oxide, nickel oxide, zinc oxide, calcium oxide, zirconium oxide, yttrium oxide, silicon carbide, boehmite, aluminum hydroxide, magnesium hydroxide, calcium hydroxide, and barium sulfate. The binder is selected from one or a combination of a polyvinylidene fluoride, a vinylidene fluoride-hexafluoropropylene copolymer, a polyamide, a polyacrylonitrile, a polyacrylate, a polyacrylic acid, a polyacrylate, a polyvinylpyrrolidone, a polyvinyl ether, a polymethyl methacrylate, a polytetrafluoroethylene, and a polyhexafluoropropylene.

The polymer layer includes a polymer, and a material of the polymer is selected from at least one of a polyamide, a polyacrylonitrile, an acrylate polymer, a polyacrylic acid, a polyacrylate, a polyvinylpyrrolidone, a polyvinyl ether, a polyvinylidene fluoride, and a poly(vinylidene fluoride-hexafluoropropylene).

### III. APPLICATION

The electrolyte according to the embodiments of this application can improve the high-temperature cycle performance, high-temperature storage performance, and kinetics of an electrochemical apparatus, and has higher safety, so that the electrochemical apparatus manufactured thereof is applicable to electronic devices in various fields.

The electrochemical apparatus according to this application is not particularly limited to any purpose, and may be used for any known purposes. For example, the electrochemical apparatus may be used for a notebook computer, a pen-input computer, a mobile computer, an electronic book player, a portable telephone, a portable fax machine, a portable copier, a portable printer, a headset, a video recorder, a liquid crystal television, a portable cleaner, a portable CD player, a mini-disc, a transceiver, an electronic notebook, a calculator, a storage card, a portable recorder, a radio, a standby power source, a motor, an automobile, a motorcycle, a motor bicycle, a bicycle, a lighting appliance, a toy, a game console, a clock, an electric tool, a flash lamp, a camera, a large household battery, a lithium-ion capacitor, or the like.

### IV. EXAMPLES

Below, this application will be further specifically described with examples and comparative examples, and this application is not limited to these examples as long as the essence of this application is not departed from.

1. Preparing a Lithium-Ion Battery

(1) Preparation of a Negative Electrode

Artificial graphite serving as a negative electrode active material, sodium carboxymethyl cellulose (CMC), and styrene butadiene rubber (SBR) serving as a binder were mixed at a weight ratio of 97:1:2. Deionized water was added. Then, the resulting mixture was stirred by a vacuum mixer to obtain a negative electrode slurry with a solid content of 54 wt %. The negative electrode slurry was applied uniformly on a copper foil negative electrode current collector. The copper foil was dried at 85° C., followed by cold pressing, cutting, and slitting. A resulting material was dried under vacuum at 120° C. for 12 hours to obtain a negative electrode.

(2) Preparation of a Positive Electrode

Preparation of positive electrodes in Example 1 to Example 56 and Comparative Example 1 to Comparative Example 6:

A lithium-nickel-cobalt-manganese ternary material (LiNi_{0.5}Co_{0.2}Mn_{0.3}O₂, NCM523 for short) serving as a positive electrode active material, Super P serving as a conductive agent, and polyvinylidene fluoride serving as a binder were mixed at a weight ratio of 97:1.4:1.6. N-methylpyrrolidone (NMP) was added. Then the mixture was stirred by a vacuum mixer to obtain a uniform and transparent positive electrode slurry. The positive electrode slurry was applied uniformly on an aluminum foil positive electrode current collector. Then the aluminum foil was dried at 85° C., followed by cold pressing, cutting, and slitting. A resulting material was dried under vacuum at 85° C. for 4 hours to obtain a positive electrode.

Preparation of positive electrodes in Example 57 to Example 62:

The method for preparing a positive electrode is the same as that in Example 1, except for the positive electrode active material used.

(3) Preparation of an Electrolyte

In a glove box under a dry argon atmosphere, ethylene carbonate (EC), propylene carbonate (PC), ethyl methyl carbonate (EMC), and diethyl carbonate (DEC) were mixed at a mass ratio of EC:PC:EMC:DEC=10:30:30:30. An additive was then added and dissolved, and the mixture was thoroughly stirred. Then, a lithium salt LiPF₆ was added and mixed uniformly to obtain an electrolyte with a concentration of LiPF₆ being 1 mol/L. Types and amounts of added substances are shown in the following tables, and a content percentage of each substance is a mass percentage calculated based on a total mass of the electrolyte.

(4) Preparation of a Separator

A 7-micron thick polyethylene (PE) separator was used.

(5) Preparation of a Lithium-Ion Battery

The positive electrode, separator, and negative electrode were stacked in order, so that the separator was placed between the positive electrode and the negative electrode for separation. Then they were wound and placed in an outer packaging aluminum foil film. Then the prepared electrolyte was injected into a dried battery, followed by processes such as vacuum packaging, standing, chemical conversion, shaping, and capacity testing, to obtain a soft-packed lithium-ion battery.

2. Performance Test of the Lithium-Ion Battery

(1) Cycle Performance Test on the Lithium-Ion Battery

The lithium-ion battery was placed in a thermostat of 25 degrees Celsius and stood for 30 minutes, so that the lithium-ion battery reached a constant temperature. The lithium-ion battery that had reached a constant temperature was charged at a constant current of 1 C to a voltage of 4.45 V, then charged at a constant voltage of 4.45 V to a current of 0.05 C, and then discharged at a constant current of 1 C to a voltage of 2.8 V. This was one charge-discharge cycle. The first discharge capacity was taken as 100%. The charge and discharge cycle was repeated until the discharge capacity decayed to 80%, and the number of cycles was recorded as an indicator to evaluate the cycle performance of the lithium-ion battery.

In addition, the cycle performance of the lithium-ion battery was tested at 45 degrees Celsius, and the test method was the same as that in the cycle performance test at 25 degrees Celsius except for the temperature.

(2) High Temperature Storage Test of the Lithium-Ion Battery (Stored at 60 Degrees Celsius for 90 Days)

The lithium-ion battery was placed in a thermostat of 25 degrees Celsius and stood for 30 minutes, so that the lithium-ion battery reached a constant temperature. The lithium-ion battery was charged at a constant current of 1 C to 4.45 V, charged at a constant voltage to a current of 0.05 C, and then discharged at a constant current of 1 C to 2.8 V, and a discharge capacity was recorded as an initial capacity of the lithium-ion battery. Then, the lithium-ion battery was charged at a constant current of 0.5 C to 4.45 V, and charged at a constant voltage to a current of 0.05 C. A thickness of the battery was measured with a micrometer and recorded. The tested lithium-ion battery was transferred to a thermostat of 60 degrees Celsius for storage for 90 days. In this period, the thickness of the battery was tested and recorded once every other 3 days. After 90 days elapsed, the battery was transferred to a 25° C. thermostat and stood for 60 minutes. The battery was discharged at a constant current of 1 C to 2.8 V, and a discharge capacity was recorded as a remaining capacity of the lithium-ion battery. The battery was charged at a constant current of 1 C to 4.45 V, charged at a constant voltage to a current of 0.05 C, and then discharged at a constant current of 1 C to 2.8 V, and a discharge capacity was recorded as a recoverable capacity of the lithium-ion battery. A thickness (Thickness, THK for short), an open circuit voltage (Open circuit voltage, OCV for short), and impedance (Impedance, IMP for short) of the battery were tested. A thickness swelling rate of the lithium-ion battery in storage was calculated as an indicator to evaluate high-temperature gas production of the lithium-ion battery:

Thickness swelling rate=(Thickness in storage−Initial thickness)/Initial thickness−100%.

(3) Direct Current Resistance DCR (0 Degrees Celsius) Test of the Lithium-Ion Battery

The lithium-ion battery was placed in a high and low temperature box of 0 degrees Celsius and stood for 4 hours, so that the lithium-ion battery reached a constant temperature. The battery was charged at a constant current of 0.1 C to 4.45 V, charged at a constant voltage to a current of 0.05 C, and stood for 10 minutes. Then, the battery was discharged at a constant current of 0.1 C to 3.4 V, and a capacity in this step was recorded as an actual discharge capacity D₀. Then, the battery was stood for 5 minutes, charged at a constant current of 0.1 C to 4.45 V, and charged at a constant voltage to a current of 0.05 C (the current was calculated based on the capacity corresponding to D₀). Then, the battery was stood for 10 minutes, and discharged by 7 H at a constant current of 0.1 C (the current was calculated based on the capacity corresponding to D₀), and a voltage V₁ at this time was recorded. Next, the battery was discharged at a constant current of 1 C for 1 second (a sample was collected every 10 milliseconds, and the current was correspondingly calculated based on a marked capacity of the battery), and a voltage V₂ at this time was recorded. Then, direct current resistance (DCR) corresponding to 30% state of charge (SOC) of the battery was calculated by using the following formula:

30% SOC DCR=(V₂−V₁)/1 C.

(4) Overcharge Test of the Lithium-Ion Battery

The battery was discharged at 0.5 C to 2.8 V at 25 degrees Celsius, charged at a constant current of 2 C to 5.4 V, and then charged at a constant voltage for 3 hours, and a change in a surface temperature of the battery was monitored (the pass criterion was that the battery neither caught fire nor burned nor exploded). 10 batteries were tested in each instance, and the number of batteries passing the test was recorded.

(5) Hot Box Test

The battery was charged at a constant current of 0.5 C to 4.45 V at 25 degrees Celsius, and charged at a constant voltage of 4.45 V until the current was less than or equal to 0.05 C. After being fully charged, the battery was placed in a high and low temperature box whose temperature was raised to 150 degrees Celsius at a rate of 5 degrees Celsius/minute, and was kept at a constant temperature of 150 degrees Celsius for 1 hour. The battery was monitored, and the pass criterion was that the battery neither caught fire nor exploded. 10 batteries were tested in each instance, and the number of batteries passing the test was recorded.

(6) Thickness Expansion Rate (%) in Floating Charge (45 Degrees Celsius, 60 Days)

The lithium-ion battery was placed in a thermostat of 45 degrees Celsius and stood for 30 minutes, so that the lithium-ion battery reached a constant temperature. The lithium-ion battery was charged at a constant current of 1 C to 4.45 V, charged at a constant voltage to a current of 0.05 C, and then discharged at a constant current of 1 C to 2.8 V, and a discharge capacity was recorded as an initial capacity of the lithium-ion battery. Then, the lithium-ion battery was charged at a constant current of 0.5 C to 4.45 V, and charged at a constant voltage for 60 days. A thickness of the battery was measured with a micrometer and recorded. In this period, the thickness of the battery was tested and measured once every other 3 days (an open circuit voltage and impedance were also recorded). After the 60 days elapsed, the battery was stood for 60 minutes and discharged at a constant current of 1 C to 2.8 V. A discharge capacity was recorded as a remaining capacity of the lithium-ion battery. The battery was charged at a constant current of 1 C to 4.45 V, charged at a constant voltage to a current of 0.05 C, and then discharged at a constant current of 1 C to 2.8 V, and a discharge capacity was recorded as a recoverable capacity of the lithium-ion battery. A thickness (Thickness, THK for short), an open circuit voltage (Open circuit voltage, OCV for short), and impedance (Impedance, IMP for short) of the battery were tested. A thickness swelling rate of the lithium-ion battery in floating charge was calculated as an indicator to evaluate high-temperature gas production of the lithium-ion battery.

Thickness swelling rate=(Thickness in floating charge−Initial thickness)/Initial thickness×100%.

A. Electrolytes and Lithium-Ion Batteries in Examples 1 to 14 and Comparative Examples 1 to 3 were Prepared According to the Foregoing Method. For Electrolyte Composition and Test Results, See Table 1 and Table 2.

TABLE 1

| | | | | | | Additive A | |
|---|---|---|---|---|---|---|---|
| | Additive B | | | | | Compound | Compound |
| | FEC | VC | LiODFB | LiPO₂F₂ | LiBF₄ | I-1 | I-2 |
| Example | (%) | (%) | (%) | (%) | (%) | (%) | (%) |
| Comparative | / | / | / | / | / | / | / |
| example 1 | | | | | | | |
| Comparative | 2 | / | / | / | / | / | / |
| example 2 | | | | | | | |
| Comparative | / | / | / | / | / | 1 | / |
| example 3 | | | | | | | |
| Example 1 | 2 | / | / | / | / | 0.01 | / |
| Example 2 | 2 | / | / | / | / | 0.1 | / |
| Example 3 | 2 | / | / | / | / | 0.5 | / |
| Example 4 | 2 | / | / | / | / | 0.9 | / |
| Example 5 | 2 | / | / | / | / | 1 | / |
| Example 6 | 2 | / | / | / | / | 2 | / |
| Example 7 | 2 | / | / | / | / | / | 1 |
| Example 8 | 2 | / | 0.5 | / | / | 1 | / |
| Example 9 | 2 | / | / | 0.5 | / | 1 | / |
| Example 10 | 2 | / | / | / | 0.2 | 1 | / |
| Example 11 | 2 | / | 0.5 | 0.5 | 0.2 | 1 | / |
| Example 12 | / | 1 | 0.5 | 0.5 | 0.2 | 1 | / |
| Example 13 | 2 | 1 | 0.5 | 0.5 | 0.2 | 1 | / |
| Example 14 | 2 | 1 | 0.5 | 0.5 | 0.2 | / | 1 |

Note:
“/” indicates no addition.

TABLE 2

| | | | Thickness swelling | |
|---|---|---|---|---|
| | Number of | Number of | rate (%) after storage | 30% SOC DCR at |
| | cycles at 25 | cycles at 45 | for 90 days at 60 | 0 degrees Celsius |
| Example | degrees Celsius | degrees Celsius | degrees Celsius | (Milliohm) |
| Comparative | 95 | 56 | 101 | 67.6 |
| example 1 | | | | |
| Comparative | 285 | 176 | 63 | 66.2 |
| example 2 | | | | |
| Comparative | 317 | 224 | 41 | 65.7 |
| example 3 | | | | |
| Example 1 | 318 | 225 | 40 | 66.1 |
| Example 2 | 347 | 238 | 37 | 66 |
| Example 3 | 465 | 319 | 35 | 65.2 |
| Example 4 | 575 | 388 | 28 | 64.3 |
| Example 5 | 583 | 418 | 26 | 64.1 |
| Example 6 | 581 | 423 | 24 | 64.2 |
| Example 7 | 592 | 422 | 25 | 64.2 |
| Example 8 | 639 | 485 | 21 | 63.5 |
| Example 9 | 644 | 495 | 20 | 63.2 |
| Example 10 | 605 | 427 | 16 | 63.4 |
| Example 11 | 679 | 508 | 14 | 62.5 |
| Example 12 | 720 | 595 | 13 | 63.2 |
| Example 13 | 745 | 627 | 14 | 63 |
| Example 14 | 747 | 633 | 13 | 63 |

From comparison of Comparative Example 1 to Comparative Example 3 and Example 1 to Example 14, it can be learned that compared with the electrolyte with neither or either of the additive A and the additive B added, the electrolyte with specific amounts of both the additive A and the additive B added could significantly improve cycle performance, high-temperature storage performance, and low-temperature impedance of the lithium-ion battery. Remarkable improvements in cycle performance, high-temperature storage performance, and low-temperature impedance of the battery were seen in Example 4 to Example 14.

B. Electrolytes and Lithium-Ion Batteries in Examples 15 to 27 and Comparative Example 4 were Prepared According to the Foregoing Method. For Electrolyte Composition and Test Results, See Table 3 and Table 4.

TABLE 3

| | Additive C | | | | Additive A | |
|---|---|---|---|---|---|---|
| | Compound | Compound | Compound | Compound | Compound | Compound |
| | II-3 (PES) | II-4 (PS) | II-1 (MMDS) | II-2 (DTD) | I-1 | I-2 |
| Example | (%) | (%) | (%) | (%) | (%) | (%) |
| Comparative | / | / | / | / | / | / |
| example 1 | | | | | | |
| Comparative | / | / | / | / | 1 | / |
| example 3 | | | | | | |
| Comparative | 1 | / | / | / | / | / |
| example 4 | | | | | | |
| Example 15 | 0.1 | / | / | / | 1 | / |
| Example 16 | 0.3 | / | / | / | 1 | / |
| Example 17 | 0.5 | / | / | / | 1 | / |
| Example 18 | 0.9 | / | / | / | 1 | / |
| Example 19 | 1 | / | / | / | 1 | / |
| Example 20 | 2 | / | / | / | 1 | / |
| Example 21 | / | 3 | / | / | 1 | / |
| Example 22 | / | / | 1 | / | 1 | / |
| Example 23 | / | / | / | 1 | 1 | / |
| Example 24 | 1 | / | / | / | / | 1 |
| Example 25 | 1 | 3 | / | 1 | 1 | / |
| Example 26 | 1 | 3 | 1 | 1 | 1 | / |
| Example 27 | 1 | 3 | 1 | 1 | / | 1 |

Note:
“/” indicates no addition.

TABLE 4

| | | | | Thickness swelling |
|---|---|---|---|---|
| | | | Thickness swelling | rate (%) in floating |
| | Number of | Number of | rate (%) after storage | charge after storage |
| | cycles at 25 | cycles at 45 | for 90 days at 60 | for 60 days at 45 |
| Example | degrees Celsius | degrees Celsius | degrees Celsius | degrees Celsius |
| Comparative | 95 | 56 | 101 | 85 |
| example 1 | | | | |
| Comparative | 317 | 224 | 41 | 32 |
| example 3 | | | | |
| Comparative | 415 | 319 | 36 | 33 |
| example 4 | | | | |
| Example 15 | 485 | 328 | 36 | 30 |
| Example 16 | 523 | 358 | 23 | 25 |
| Example 17 | 620 | 454 | 13 | 17 |
| Example 18 | 745 | 601 | 8 | 10 |
| Example 19 | 769 | 635 | 6 | 8 |
| Example 20 | 775 | 675 | 5 | 7 |
| Example 21 | 523 | 368 | 15 | 14 |
| Example 22 | 535 | 401 | 14 | 13 |
| Example 23 | 545 | 423 | 13 | 13 |
| Example 24 | 777 | 639 | 7 | 8 |
| Example 25 | 865 | 691 | 5 | 5 |
| Example 26 | 950 | 765 | 4 | 4 |
| Example 27 | 971 | 785 | 4 | 4 |

From comparison of Comparative Examples 1, 3, and 4 and Examples 15 to 27, it can be learned that compared with the electrolyte neither or either of the additive A and the additive C added, the electrolyte with specific amounts of both the additive A and the additive C added could significantly improve cycle performance, high-temperature storage performance, and floating charge performance of the lithium-ion battery. Remarkable improvements in cycle performance, high-temperature storage performance, and floating charge performance of the battery were seen in Example 17 to Example 20 and Example 24 to Example 27.

C. Electrolytes and Lithium-Ion Batteries in Examples 28 to 41 and Comparative Example 5 were Prepared According to the Foregoing Method. For Electrolyte Composition and Test Results, See Table 5 and Table 6.

TABLE 5

| | Additive D | | | | Additive A | |
|---|---|---|---|---|---|---|
| | Compound | Compound | Compound | Compound | Compound | Compound |
| | III-B1 | III-B2 | III-A2 | III-C2 | I-1 | I-2 |
| Example | (%) | (%) | (%) | (%) | (%) | (%) |
| Comparative | / | / | / | / | / | / |
| example 1 | | | | | | |
| Comparative | / | / | / | / | 1 | / |
| example 3 | | | | | | |
| Comparative | 2 | / | / | / | / | / |
| example 5 | | | | | | |
| Example 28 | 0.1 | / | / | / | 1 | / |
| Example 29 | 0.5 | / | / | / | 1 | / |
| Example 30 | 1 | / | / | / | 1 | / |
| Example 31 | 2 | / | / | / | 1 | / |
| Example 32 | 3 | / | / | / | 1 | / |
| Example 33 | 5 | / | / | / | 1 | / |
| Example 34 | 10 | / | / | / | 1 | / |
| Example 35 | / | 2 | / | / | 1 | / |
| Example 36 | / | / | 2 | / | 1 | / |
| Example 37 | / | / | / | 2 | 1 | / |
| Example 38 | 2 | / | / | / | / | 1 |
| Example 39 | 1 | 1 | 1 | / | 1 | / |
| Example 40 | 1 | 1 | 1 | 1 | 1 | / |
| Example 41 | 1 | 1 | 1 | 1 | / | 1 |

Note:
“/” indicates no addition.

TABLE 6

| | | Thickness swelling | |
|---|---|---|---|
| | Thickness swelling | rate (%) in floating | Number of batteries |
| | rate (%) after storage | charge after storage | passing the test out of |
| | for 90 days at 60 | for 60 days at 45 | 10 batteries in the |
| Example | degrees Celsius | degrees Celsius | overcharge test |
| Comparative | 101 | 85 | 0 |
| example 1 | | | |
| Comparative | 41 | 32 | 3 |
| example 3 | | | |
| Comparative | 39 | 30 | 3 |
| example 5 | | | |
| Example 28 | 35 | 27 | 3 |
| Example 29 | 23 | 25 | 4 |
| Example 30 | 18 | 12 | 5 |
| Example 31 | 10 | 9 | 9 |
| Example 32 | 6 | 7 | 9 |
| Example 33 | 5 | 6 | 10 |
| Example 34 | 5 | 6 | 10 |
| Example 35 | 9 | 8 | 9 |
| Example 36 | 11 | 10 | 9 |
| Example 37 | 7 | 8 | 9 |
| Example 38 | 8 | 7 | 9 |
| Example 39 | 5 | 5 | 10 |
| Example 40 | 4 | 4 | 10 |
| Example 41 | 4 | 4 | 10 |

From comparison of Comparative Examples 1, 3, and 5 and Examples 28 to 41, it can be learned that compared with the electrolyte with neither or either of the additive A and the additive D added, the electrolyte with specific amounts of both the additive A and the additive D added could significantly improve high-temperature storage performance, floating charge performance, and overcharge performance of the lithium-ion battery. Remarkable improvements in high-temperature storage performance, floating charge performance, and overcharge performance of the battery were seen in Example 31 to Example 40.

D. Electrolytes and Lithium-Ion Batteries in Examples 42 to 50 and Comparative Example 6 were Prepared According to the Foregoing Method. For Electrolyte Composition and Test Results, See Table 7 and Table 8.

TABLE 7

| | Additive A | | Additive E | |
|---|---|---|---|---|
| | Compound | Compound | Compound | Compound |
| | I-1 | I-2 | IV-A1 | IV-A2 |
| Example | (%) | (%) | (%) | (%) |
| Comparative | / | / | / | / |
| example 1 | | | | |
| Comparative | 1 | / | / | / |
| example 3 | | | | |
| Comparative | / | / | 10 | / |
| example 6 | | | | |
| Example 42 | 1 | / | 1 | / |
| Example 43 | 1 | / | 3 | / |
| Example 44 | 1 | / | 5 | / |
| Example 45 | 1 | / | 7 | / |
| Example 46 | 1 | / | 10 | / |
| Example 47 | 1 | / | 15 | / |
| Example 48 | 1 | / | 20 | / |
| Example 49 | / | 1 | 10 | / |
| Example 50 | 1 | / | / | 10 |

Note:
“/” indicates no addition.

TABLE 8

| | | Number of batteries | |
|---|---|---|---|
| | Thickness swelling | passing the test out of | Number of batteries |
| | rate (%) after storage | 10 batteries in the hot | passing the test out of |
| | for 90 days at 60 | box test (150 degrees | 10 batteries in the |
| Example | degrees Celsius | Celsius, 1 hour) | overcharge test |
| Comparative | 101 | 0 | 0 |
| example 1 | | | |
| Comparative | 41 | 3 | 3 |
| example 3 | | | |
| Comparative | 45 | 3 | 3 |
| example 6 | | | |
| Example 42 | 38 | 3 | 3 |
| Example 43 | 33 | 4 | 3 |
| Example 44 | 29 | 5 | 4 |
| Example 45 | 24 | 8 | 5 |
| Example 46 | 10 | 10 | 10 |
| Example 47 | 9 | 10 | 10 |
| Example 48 | 8 | 10 | 10 |
| Example 49 | 8 | 10 | 10 |
| Example 50 | 9 | 10 | 10 |

From comparison of Comparative Examples 1, 3, and 6 and Examples 42 to 50, it can be learned that compared with the electrolyte with neither or either of the additive A and the additive E added, the electrolyte with specific amounts of both the additive A and the additive E added could significantly improve high-temperature storage and overcharge performance of the lithium-ion battery. Remarkable improvements in high-temperature storage and overcharge performance of the battery were seen in Example 46 to Example 50.

E. Electrolytes and Lithium-Ion Batteries in Example 51 to Example 56 were Prepared According to the Foregoing Method and Compared with Those in Comparative Example 1, Example 9, Example 21, Example 31, and Example 46. For Electrolyte Composition and Test Results, See Table 9 and Table 10.

TABLE 9

| | Additive A | | | | Additive C | | Additive D | Additive E |
|---|---|---|---|---|---|---|---|---|
| | Compound | Compound | Additive B | | Compound | Compound | Compound | Compound |
| | I-1 | I-2 | LiPO₂F₂ | FEC | II-3 (PES) | II-4 (PS) | III-B1 | IV-A1 |
| Example | (%) | (%) | (%) | (%) | (%) | (%) | (%) | (%) |
| Comparative | / | / | / | / | / | / | / | / |
| example 1 | | | | | | | | |
| Example 9 | 1 | / | 0.5 | 2 | / | / | / | / |
| Example 21 | 1 | / | / | / | / | 3 | / | / |
| Example 31 | 1 | / | / | / | / | / | 2 | / |
| Example 46 | 1 | / | / | / | / | / | / | 10 |
| Example 51 | 1 | / | 0.5 | 2 | / | 3 | / | / |
| Example 52 | 1 | / | 0.5 | 2 | 0.5 | 3 | / | / |
| Example 53 | 1 | / | 0.5 | 2 | 0.5 | 3 | 2 | / |
| Example 54 | 1 | / | 0.5 | 2 | 0.5 | 3 | / | 10 |
| Example 55 | 1 | / | 0.5 | 2 | 0.5 | 3 | 2 | 10 |
| Example 56 | / | 1 | 0.5 | 2 | 0.5 | 3 | 2 | 10 |

Note:
“/” indicates no addition.

TABLE 10

| | | | | Thickness swelling | |
|---|---|---|---|---|---|
| | | | Thickness swelling | rate (%) in floating | Number of batteries |
| | Number of | Number of | rate (%) after storage | charge after storage | passing the test out of |
| | cycles at 25 | cycles at 45 | for 90 days at 60 | for 60 days at 45 | 10 batteries in the |
| Example | degrees Celsius | degrees Celsius | degrees Celsius | degrees Celsius | overcharge test |
| Example 1 | 95 | 56 | 101 | 85 | 0 |
| Example 9 | 644 | 495 | 20 | 17 | 4 |
| Example 21 | 523 | 368 | 15 | 14 | 4 |
| Example 31 | 575 | 401 | 10 | 9 | 9 |
| Example 46 | 567 | 455 | 10 | 10 | 10 |
| Example 51 | 699 | 515 | 14 | 13 | 6 |
| Example 52 | 851 | 697 | 7 | 10 | 7 |
| Example 53 | 890 | 724 | 5 | 6 | 10 |
| Example 54 | 995 | 801 | 6 | 6 | 10 |
| Example 55 | 1037 | 835 | 4 | 4 | 10 |
| Example 56 | 1021 | 827 | 4 | 4 | 10 |

From comparison of Examples 9, 21, 31, and 46 and Example 51 to Example 56, it can be learned that when specific amounts of the additive A and two or more additives selected from the additive B, the additive C, the additive D, and the additive E were jointly added into the electrolyte, excellent high-temperature storage performance, cycle performance, floating charge performance, and overcharge performance of the lithium-ion battery could all be achieved.

F. Electrolytes, Positive Electrode Materials, and Lithium-Ion Batteries in Example 57 to Example 62 were Prepared According to the Foregoing Method and Compared with Those in Example 53. The Electrolyte Composition in Example 57 to Example 62 was the Same as that in Example 53. For Parameters and Test Results of the Positive Electrode Active Materials, See Table 11 and Table 12.

TABLE 11

| | Particle size | | Doped with Al | Doped with Ti |
|---|---|---|---|---|
| | Dv50 | Dv90 | Al (ppm) | Ti (ppm) |
| Example 53 | 4.5 | 8.5 | / | / |
| Example 57 | 4.5 | 8.5 | 3000 | / |
| Example 58 | 4.5 | 8.5 | / | 1000 |
| Example 59 | 4.5 | 8.5 | / | 3000 |
| Example 60 | 4.5 | 8.5 | 3000 | 3000 |
| Example 61 | 8 | 15.5 | 3000 | 3000 |
| Example 62 | 10 | 22 | 3000 | 3000 |

Note:
“/” indicates no addition.

TABLE 12

| | | | | Thickness swelling | |
|---|---|---|---|---|---|
| | | | Thickness swelling | rate (%) in floating | Number of batteries |
| | Number of | Number of | rate (%) after storage | charge after storage | passing the test out of |
| | cycles at 25 | cycles at 45 | for 90 days at 60 | for 60 days at 45 | 10 batteries in the |
| Example | degrees Celsius | degrees Celsius | degrees Celsius | degrees Celsius | overcharge test |
| Example 53 | 890 | 724 | 5 | 6 | 10 |
| Example 57 | 951 | 815 | 4 | 5 | 10 |
| Example 58 | 973 | 849 | 4 | 5 | 10 |
| Example 59 | 1077 | 894 | 3 | 4 | 10 |
| Example 60 | 1101 | 931 | 3 | 3 | 10 |
| Example 61 | 1157 | 965 | 2 | 2 | 10 |
| Example 62 | 1161 | 977 | 2 | 2 | 10 |

From comparison of Example 53 and Example 57 to Example 62, it can be learned that in the battery using the electrolyte of the present invention, when the particle size of the positive electrode active material was optimized, or when the positive electrode active material was further doped and modified (for example, adding an element such as Al or Ti), better high-temperature storage, cycle, floating charge, and overcharge performance of the lithium-ion battery could be achieved.

In conclusion, the foregoing examples show that the electrolyte provided in the present invention can improve two or more of high-temperature storage, low-temperature impedance, floating charge, and overcharge performance of an electrochemical apparatus.

The above are only a few embodiments of the present invention, which do not limit the present invention in any form. Although the present invention is disclosed as above with preferred embodiments, these embodiments are not intended to limit the present invention. Changes or modifications made by those skilled in the art using the technical content disclosed above without departing from the scope of the technical solution of the present invention are considered as equivalent embodiments and fall within the scope of the technical solution.

References to “some embodiments”, “some of the embodiments”, “an embodiment”, “another example”, “examples”, “specific examples” or “some examples” in the specification mean the inclusion of specific features, structures, materials, or characteristics described in the embodiment or example in at least one embodiment or example of this application. Accordingly, descriptions appearing in the specification, such as “in some embodiments”, “in the embodiments”, “in an embodiment”, “in another example”, “in an example”, “in a particular example”, or “for example”, are not necessarily references to the same embodiments or examples in this application. In addition, specific features, structures, materials, or characteristics herein may be incorporated in any suitable manner into one or more embodiments or examples. Although illustrative embodiments have been demonstrated and described, those skilled in the art should understand that the above embodiments are not to be construed as limiting this application, and that the embodiments may be changed, replaced, and modified without departing from the spirit, principle, and scope of this application.

1. An electrolyte, comprising:
an additive A, wherein the additive A comprises a non-fluorinated lithium borate compound; and
at least one additive selected from an additive B, an additive C, an additive D, or an additive E, wherein
the additive B comprises at least one of vinylene carbonate, fluoroethylene carbonate, lithium tetrafluoroborate, lithium difluoro(oxalato)borate, or lithium difluorophosphate;
the additive C comprises a compound comprising S═O;
the additive D comprises a compound having 2 to 4 cyano groups; and
the additive E comprises a silicon-containing carbonate compound.

2. The electrolyte according to claim 1, wherein the non-fluorinated lithium borate compound comprises at least one of a compound I-1, a compound I-2, a compound I-3, a compound I-4, or a compound I-5:

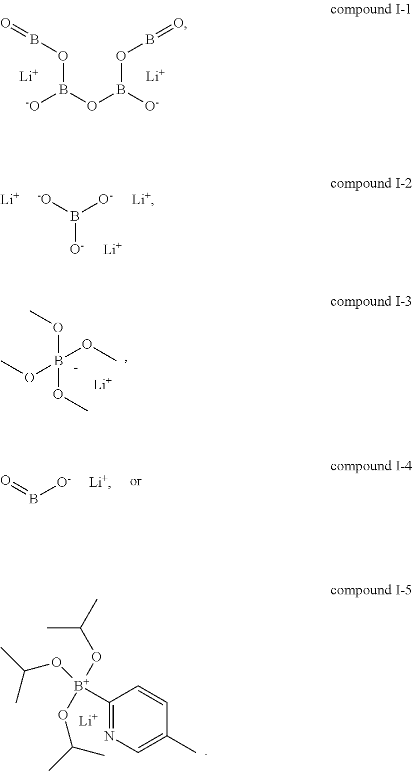

3. The electrolyte according to claim 1, wherein the electrolyte comprises the additive B; based on a total weight of the electrolyte, a weight ratio of the additive A to the additive B is 1:1 to 1:200, the additive A is 0.01% to 2%, and the additive B is 0.1% to 10%.

4. The electrolyte according to claim 1, wherein the electrolyte comprises the additive B, and the additive B comprises lithium difluorophosphate, wherein based on a total weight of the electrolyte, a weight ratio of the additive A to the lithium difluorophosphate is 10:1 to 1:1, and the lithium difluorophosphate is 0.01% to 1% by weight with respect to the total weight of the electrolyte.

5. The electrolyte according to claim 1, wherein the electrolyte comprises the additive C,
the additive C comprises at least one of a compound represented by a formula II-A, a compound represented by a formula II-B, a compound represented by a formula II-C, or a compound represented by a formula II-D: 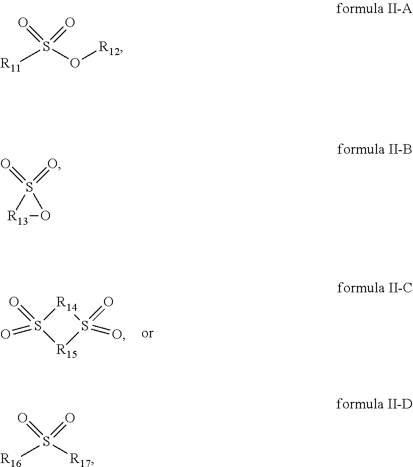
wherein
R₁₁ and R₁₂ each are independently selected from a substituted or unsubstituted C₁₋₁₀ alkyl group, a substituted or unsubstituted C₂₋₁₀ alkenyl group, a substituted or unsubstituted C₆₋₁₀ aryl group, or a substituted or unsubstituted C₁₋₆ heterocyclic group, wherein when substitution is performed, a substituent group is one or more of a halogen, a nitro group, a cyano group, or a carboxyl group, and a heteroatom of the heterocyclic group is selected from at least one of O, N, P, and S,
R₁₃ is selected from a substituted or unsubstituted C₁₋₄ alkylidene group, a substituted or unsubstituted C₂₋₄ alkenylene group, or a substituted and unsubstituted C₁₋₆ linear alkane comprising 1 to 5 heteroatoms, wherein when substitution is performed, a substituent group is selected from an oxy group, a halogen, a C₁₋₃ alkyl group, or a C₂₋₄ alkenyl group, and the heteroatom is selected from O, N, P or S,
R₁₄ and R₁₅ each are independently selected from O, a substituted or unsubstituted C₁₋₄ alkylidene group, a substituted or unsubstituted C₂₋₄ alkenylene group, or a substituted and unsubstituted C₁₋₆ linear alkane comprising 1 to 5 heteroatoms, wherein being substituted means that substitution is performed with one or more substituent groups selected from a halogen, a C₁₋₃ alkyl group, or a C₂₋₄ alkenyl group, and the heteroatom is selected from O, N, P or S, and
R₁₆ and R₁₇ each are independently selected from a substituted or unsubstituted C₁₋₄ alkyl group or a substituted or unsubstituted C₂₋₄ alkenyl group; or R₁₆ and R₁₇ are connected together to form a saturated/unsaturated and substituted/unsubstituted ring comprising 3 to 6 carbons, wherein being substituted means that substitution is performed with one or more substituent groups selected from a halogen, a C₁₋₃ alkyl group, or a C₂₋₄ alkenyl group; and
the additive C is 0.1% to 10% by weight with respect to the total weight of the electrolyte.

6. The electrolyte according to claim 1, wherein the electrolyte comprises the additive D; and
the additive D comprises at least one of a compound represented by a formula III-A, a compound represented by a formula III-B, a compound represented by a formula III-C, or a compound represented by a formula III-D: 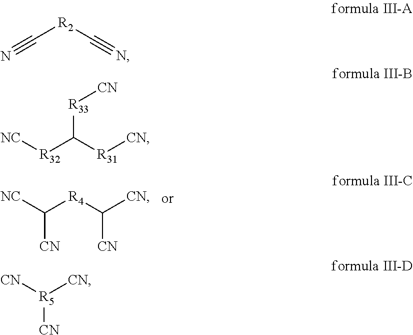
wherein
R₂ is selected from a C₂₋₁₀ alkenylene group, a C₆₋₁₂ cycloalkylidene group, a C₆₋₁₂ arylene group, —R₀—C₆₋₁₂ arylene-R—, —R₀—S—R—, or —R₀—(O—R)ₙ—,
R₃₁, R₃₂, and R₃₃ each are independently selected from a single bond, a C₁₋₆ alkylidene group, —R₀—(O—R)ₙ—, or —O—R—,
R₄ is selected from a C₁₋₁₀ alkylidene group, a C₂₋₁₀ alkenylene group, a C₆₋₁₂ cycloalkylidene group, a C₆₋₁₂ arylene group, —R₀—S—R—, or —R₀—(O—R)ₙ—,
R₅ is selected from a C₆₋₁₂ trivalent cycloalkyl group or a C₆₋₁₂ trivalent aryl group, wherein the C₆₋₁₂ trivalent cycloalkyl group or C₆₋₁₂ trivalent aryl group is arbitrarily substituted with 1 to 3 substituent groups selected from a halogen,
R₀ and R each are independently a C₁₋₄ alkylidene group, and
R₂, R₄, R₀, and R each are unsubstituted or substituted with one or more substituent groups selected from a halogen, wherein
n is a natural number from 0 to 3; and
the additive D is 0.1% to 12% by weight with respect to the total weight of the electrolyte.

7. The electrolyte according to claim 1, wherein the electrolyte comprises the additive C and the additive D;
the additive C comprises at least one of 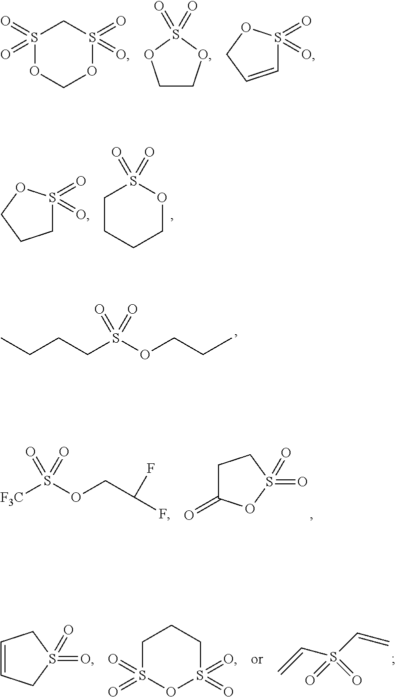
and
the additive D comprises
at least one of

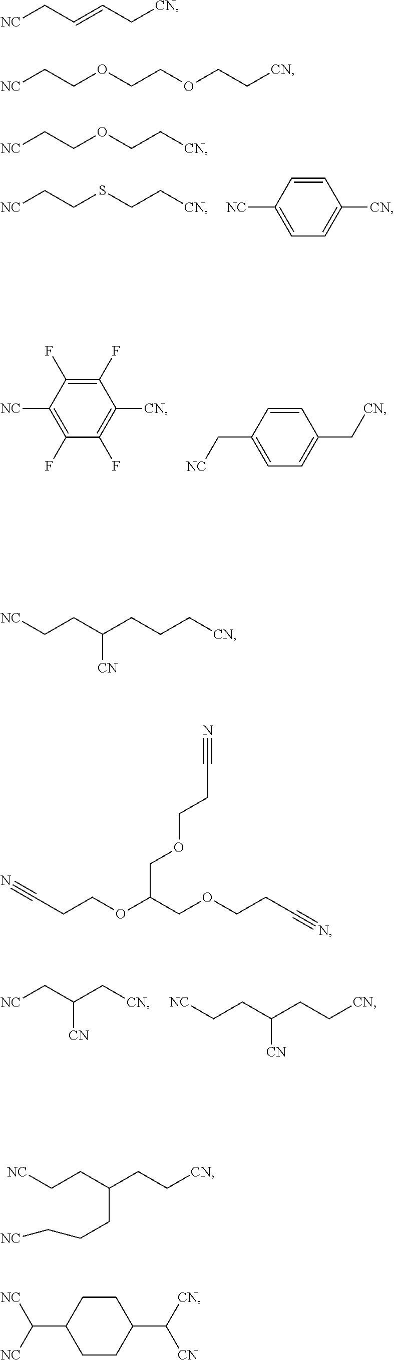

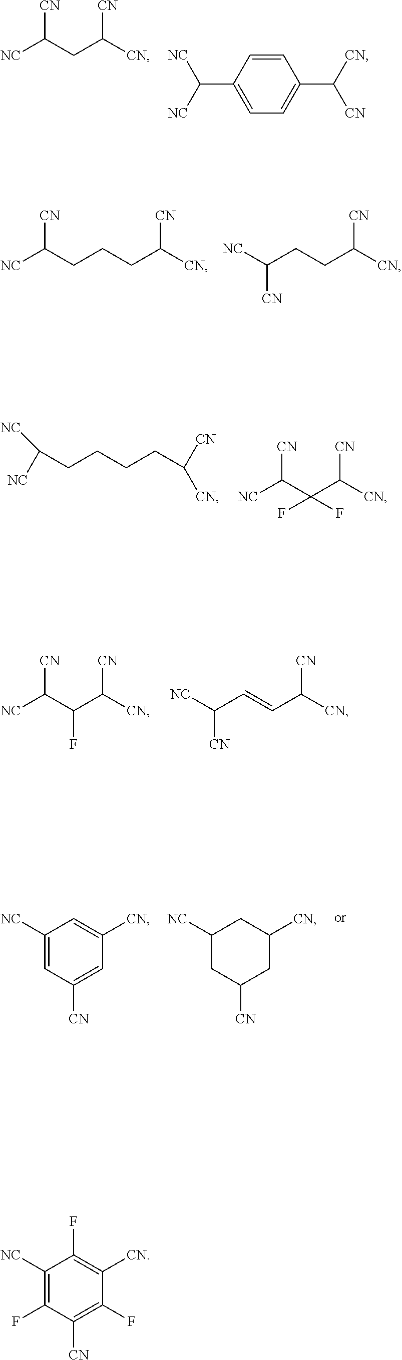

8. The electrolyte according to claim 1, wherein the electrolyte comprises the additive E; and the silicon-containing carbonate compound comprises at least one of a compound represented by a formula IV-A or a compound represented by a formula IV-B: 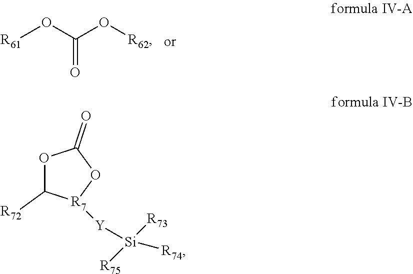
wherein R₆₁ and R₆₂ each are independently selected from R^{a}, 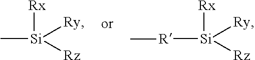
and at least one of R₆₁ and R₆₂ comprises Si,
R^{a}, Rx, Ry, and Rz each are independently selected from H, a substituted or unsubstituted C₁₋₁₀ alkyl group, a substituted or unsubstituted C₂₋₁₀ alkenyl group, a substituted or unsubstituted C₆₋₁₀ cycloalkyl group, or a substituted or unsubstituted C₆₋₁₀ aryl group, wherein being substituted means that substitution is performed with one or more halogens atoms,
R′ is selected from a substituted or unsubstituted C₁₋₁₂ alkylidene group or a substituted or unsubstituted C₂₋₁₂ alkenylene group, wherein being substituted means that substitution is performed with one or more halogen atoms,
R₇ is 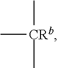
wherein R^{b} is selected from H, a halogen, a substituted or unsubstituted C₁₋₆ alkyl group, or a substituted or unsubstituted C₂₋₆ alkenyl group, wherein being substituted means that substitution is performed with one or more halogens,
Y is selected from a single bond, a substituted or unsubstituted C₁₋₄ alkylidene group, or a substituted or unsubstituted C₂₋₄ alkenylene group, wherein being substituted means that substitution is performed with one or more halogens atoms,
R₇₂ is selected from H, a halogen, a substituted or unsubstituted C₁₋₆ alkyl group, a substituted or unsubstituted C₁₋₆ alkoxy group, a substituted or unsubstituted C₂₋₆ alkenyl group, or a substituted or unsubstituted C₆₋₁₀ aryl group, wherein being substituted means that substitution is performed with one or more substituent groups selected from a halogen, and
R₇₃, R₇₄, and R₇₅ each are independently selected from H, a substituted or unsubstituted C₁₋₆ alkyl group, a substituted or unsubstituted C₁₋₆ alkoxy group, a aryl group, wherein being substituted means that substitution is performed with one or more substituent groups selected from a halogen, a C₁₋₆ alkyl group, or a C₂₋₆ alkenyl group; and
the additive E is 0.1% to 22% by weight with respect to the total weight of the electrolyte.

9. The electrolyte according to claim 8, wherein the silicon-containing carbonate compound comprises:
at least one of

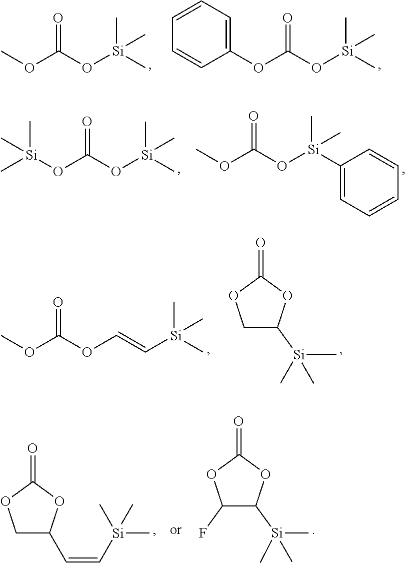

10. An electrochemical apparatus, comprising a positive electrode, a negative electrode, and the electrolyte comprising:
an additive A, wherein the additive A comprises a non-fluorinated lithium borate compound; and
at least one additive selected from an additive B, an additive C, an additive D, or an additive E, wherein
the additive B comprises at least one of vinylene carbonate, fluoroethylene carbonate, lithium tetrafluoroborate, lithium difluoro(oxalato)borate, or lithium difluorophosphate;
the additive C comprises a compound comprising S═O;
the additive D comprises a compound having 2 to 4 cyano groups; and
the additive E comprises a silicon-containing carbonate compound.

11. The electrochemical apparatus according to claim 10, wherein the positive electrode comprises a positive electrode active material, and particles of the positive electrode active material satisfy at least one of criteria (a) to (c):
(a) 0.4 microns≤Dv50≤20 microns;
(b) 2 microns≤Dv90≤40 microns; and
(c) the positive electrode active material comprises an element A, wherein the element A is selected from at least one of Al, Mg, Ti, Cr, B, Fe, Zr, Y, Na, or S, and the element A is less than 0.5% by weight with respect to the total weight of the positive electrode active material.

12. An electronic apparatus, comprising a electrochemical apparatus, wherein the electrochemical apparatus comprising a positive electrode, a negative electrode, and the electrolyte comprising:
an additive A, wherein the additive A comprises a non-fluorinated lithium borate compound; and
at least one additive selected from an additive B, an additive C, an additive D, or an additive E, wherein
the additive B comprises at least one of vinylene carbonate, fluoroethylene carbonate, lithium tetrafluoroborate, lithium difluoro(oxalato)borate, or lithium difluorophosphate;
the additive C comprises a compound comprising S═O;
the additive D comprises a compound having 2 to 4 cyano groups; and
the additive E comprises a silicon-containing carbonate compound.

13. The electrolyte according to claim 1, wherein the electrolyte comprises the additive B; the additive A is 0.01% to 2% by weight with respect to the total weight of the electrolyte, and the additive B is 0.1% to 10% by weight with respect to the total weight of the electrolyte.

14. The electrochemical apparatus according to claim 11, wherein the non-fluorinated lithium borate compound comprises at least one of a compound I-1, a compound I-2, a compound I-3, a compound I-4, or a compound I-5:

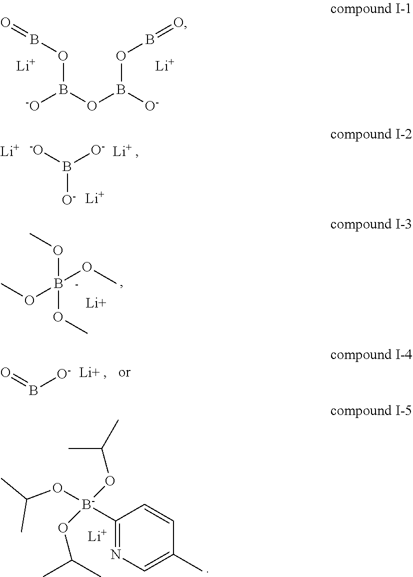

15. The electrochemical apparatus according to claim 11, wherein based on a total weight of the electrolyte, a weight ratio of the additive A to the additive B is 1:1 to 1:200.

16. The electrochemical apparatus according to claim 11, wherein the electrolyte comprises the additive B; the additive A is 0.01% to 2% by weight with respect to the total weight of the electrolyte, and the additive B is 0.1% to 10% by weight with respect to the total weight of the electrolyte.

17. The electrochemical apparatus according to claim 11, wherein the electrolyte comprises the additive B; the additive B comprises lithium difluorophosphate, wherein based on a total weight of the electrolyte, a weight ratio of the additive A to the lithium difluorophosphate is 10:1 to 1:1, and a content percentage of the lithium difluorophosphate is 0.01% to 1%.

18. The electrochemical apparatus according to claim 11, wherein the electrolyte comprises the additive D;
the additive D comprises at least one of a compound represented by a formula III-A, a compound represented by a formula III-B, a compound represented by a formula III-C, or a compound represented by a formula III-D: 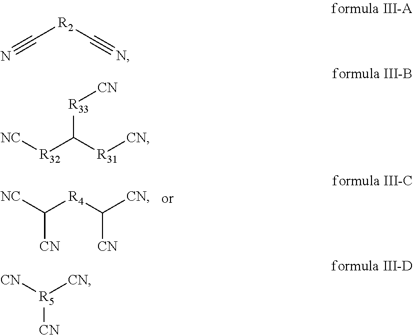
wherein
R₂ is selected from a C₂₋₁₀ alkenylene group, a C₆₋₁₂ cycloalkylidene group, a C₆₋₁₂ arylene group, —R₀—C₆₋₁₂ arylene-R—, —R₀—S—R—, or —R₀—(O—R)ₙ—,
R₃₁, R₃₂, and R₃₃ each are independently selected from a single bond, a C₁₋₆ alkylidene group, —R₀—(O—R)ₙ—, or —O—R—,
R₄ is selected from a C₁₋₁₀ alkylidene group, a C₂₋₁₀ alkenylene group, a C₆₋₁₂ cycloalkylidene group, a C₆₋₁₂ arylene group, —R₀—S—R—, or —R₀—(O—R)ₙ—,
R₅ is selected from a C₆₋₁₂ trivalent cycloalkyl group or a C₆₋₁₂ trivalent aryl group, wherein the C₆₋₁₂ trivalent cycloalkyl group or C₆₋₁₂ trivalent aryl group is arbitrarily substituted with 1 to 3 substituent groups selected from a halogen,
R₀ and R each are independently a C₁₋₄ alkylidene group, and
R₂, R₄, R₀, and R each are unsubstituted or substituted with one or more substituent groups selected from a halogen, wherein
n is a natural number from 0 to 3; and
the additive D is 0.1% to 12% by weight with respect to the total weight of the electrolyte.

19. The electrochemical apparatus according to claim 11, wherein the electrolyte comprises the additive C and the additive D; the additive C comprises:
at least one of 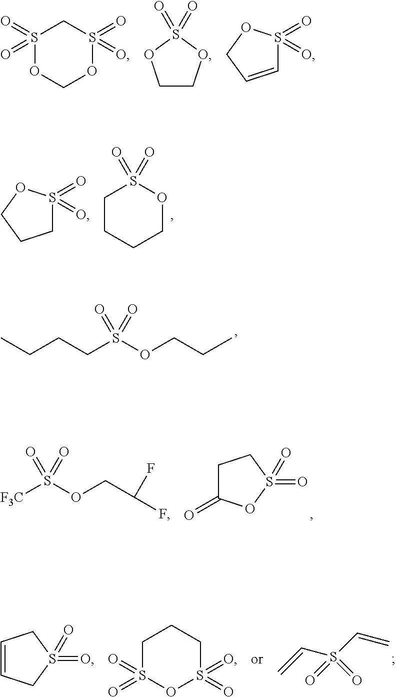
and
the additive D comprises
at least one of

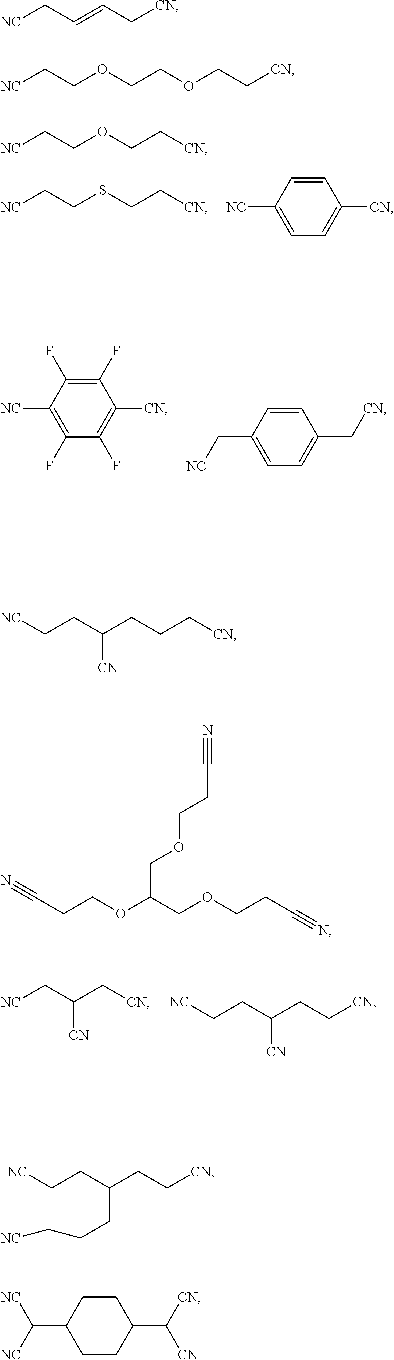

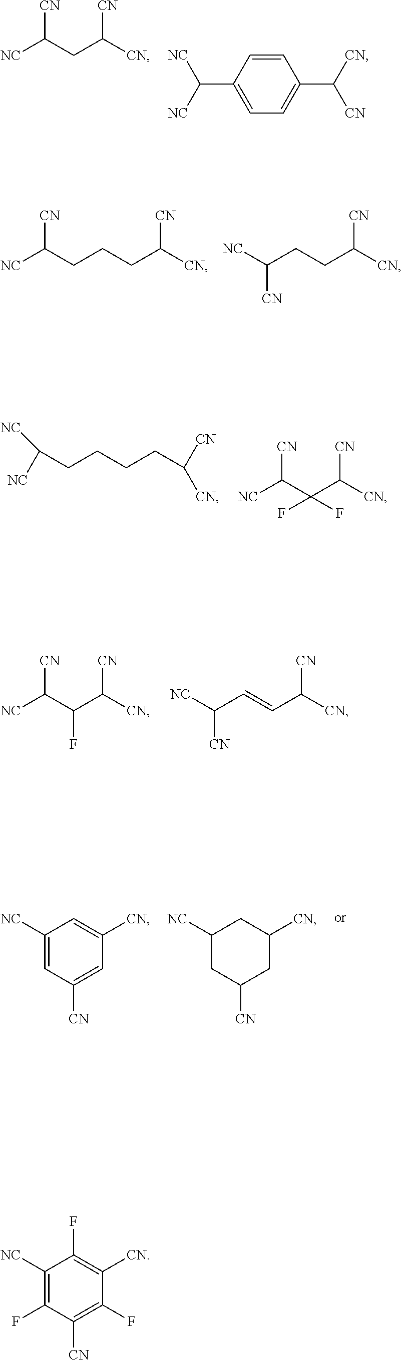

20. The electrolyte according to claim 11, wherein electrolyte comprises the additive E; and the silicon-containing carbonate compound comprises at least one of a compound represented by a formula IV-A or a compound represented by a formula IV-B: 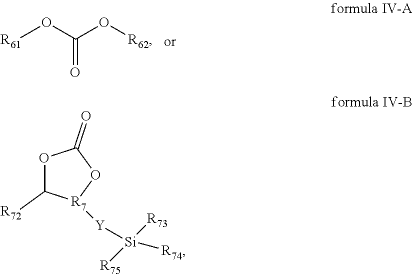
wherein R₆₁ and R₆₂ each are independently selected from R^{a}, 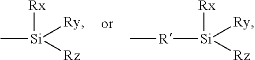
and at least one of R₆₁ and R₆₂ comprises Si,
R^{a}, Rx, Ry, and Rz each are independently selected from H, a substituted or unsubstituted C₁₋₁₀ alkyl group, a substituted or unsubstituted C₂₋₁₀ alkenyl group, a substituted or unsubstituted C₆₋₁₀ cycloalkyl group, or a substituted or unsubstituted C₆₋₁₀ aryl group, wherein being substituted means that substitution is performed with one or more halogen atoms,
R′ is selected from a substituted or unsubstituted C₁₋₁₂ alkylidene group or a substituted or unsubstituted C₂₋₁₂ alkenylene group, wherein being substituted means that substitution is performed with one or more halogen atoms,
R₇ is 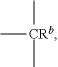
wherein R^{b} is selected from H, a halogen, a substituted or unsubstituted C₁₋₆ alkyl group, or a substituted or unsubstituted C₂₋₆ alkenyl group, wherein being substituted means that substitution is performed with one or more halogens,
Y is selected from a single bond, a substituted or unsubstituted C₁₋₄ alkylidene group, or a substituted or unsubstituted C₂₋₄ alkenylene group, wherein being substituted means that substitution is performed with one or more halogen atoms,
R₇₂ is selected from H, a halogen, a substituted or unsubstituted C₁₋₆ alkyl group, a substituted or unsubstituted C₁₋₆ alkoxy group, a substituted or unsubstituted C₂₋₆ alkenyl group, or a substituted or unsubstituted C₆₋₁₀ aryl group, wherein being substituted means that substitution is performed with one or more substituent groups selected from a halogen, and
R₇₃, R₇₄, and R₇₅ each are independently selected from H, a substituted or unsubstituted C₁₋₆ alkyl group, a substituted or unsubstituted C₁₋₆ alkoxy group, a aryl group, wherein being substituted means that substitution is performed with one or more substituent groups selected from a halogen, a C₁₋₆ alkyl group, or a C₂₋₆ alkenyl group; and
the additive E is 0.1% to 22% by weight with respect to the total weight of the electrolyte.
